(19) United States
(12) Patent Application Publication
(10) Pub. No.: US 2019/0168728 A1
(43) Pub. Date: Jun. 6, 2019

(54) System and Method for Adaptive Braking

(71) Applicant: Westinghouse Air Brake Technologies Corporation, Wilmerding, PA (US)

(72) Inventors: Sathya Vagheeswar Venkatasubramanian, Pittsburgh, PA (US); M. Frank Wilson, Cedar Rapids, IA (US)

(21) Appl. No.: 15/829,423

(22) Filed: Dec. 1, 2017

(51) Int. Cl. B60T 13/66; B60T 17/22; B61C 17/12; B60T 13/36

(52) U.S. Cl. CPC B60T 13/665; B60T 17/228; B60T 2270/84; B60T 13/365; B61C 17/12

(57) ABSTRACT

In a method of braking a number of rail cars of a train travelling on a mainline track, in response to a unique braking command provided to each rail car of a first subset of rail cars, wherein each braking command includes a level or percentage of braking the brakes of the rail car are to assume, the brakes of the rail car are set to level or percentage of braking included in the unique braking command provided to the rail car. Thereafter, in response to a unique braking command provided to each rail car of a second, different subset of rail cars, the brakes of the rail car are set to level or percentage of braking included in the unique braking command provided to the rail car.

### BACKGROUND OF THE INVENTION

### Field of the Invention

The present invention relates to a method of controlling a train equipped with an electronically controlled pneumatic (ECP) braking system,

### Description of Related Art

A traditional train braking system uses pneumatic valves to control and generate brake applications on the rail cars along the length of the train, which train, in an example, can include a locomotive and one, or two, or more rail cars. In general, this traditional system includes a brake pipe that runs the entire length of the train and which supplies air from an air compressor located the locomotive to air reservoirs mounted on each of the rail cars and the locomotive. When it is desired to apply the brakes of the train, one or more manually operated brake control valves in the locomotive are adjusted by an operator thereby causing a reduction in the brake pipe air pressure. As the brake pipe pressure reduces, the brake service portion on each rail car diverts pressurized air from the rail car's brake cylinders, whereupon the brakes of the rail car engage to a level related to the pressure of the air remaining in the brake cylinders, i.e., less air pressure in the brake cylinders equates to a higher level of braking. In order to release the brakes, the engineer charges the brake pipe with pressurized air supplied from the air compressor on the locomotive. This increases the air pressure within the brake pipe resulting in a reduced flow of air from the air reservoir on the rail cars further resulting in reduced braking.

One of the drawbacks of such air brake systems is reaction time. For example, for trains with, for example, 100 or more rail cars, it can take up to two minutes or more from the time the manually operated brake control valves are adjusted for the reduction in the brake pipe air pressure to propagate from the locomotive to the rail car at tail end of the train. This results in rail cars applying brakes at different points in time. This uneven braking can cause significant in-train forces to build up between the rail cars in a train. In order to reduce the propagation delay, most trains were equipped with a caboose or a brake van at the trailing end of the train. Today, the caboose is replaced with an End-of-Train (EOT) device that is coupled to the end of the brake pipe to serve a similar purpose of the caboose.

In contrast, ECP braking uses electronic controls which make it possible to activate air-powered brakes on the cars significantly faster and synchronously. On an ECP-equipped train, the rail cars are equipped with a trainline (a physical communication cable) that runs the length of the train. The trainline is used to (a) supply power to the electronic components installed on the cars and (b) to facilitate electronic communication between the locomotive, the rail cars and an End of Train (EOT) device, i.e., send commands from the locomotive and receive feedback from the rail cars and an End of Train (EOT) device.

ECP braking provides many benefits over the traditional braking system. For example, since all the rail cars receive the brake command at the same time, the brakes of the rail cars can be applied more uniformly and substantially instantaneously. This can provide better train braking control, can shorten a stopping distance of the train, and can lower the risk of derailment or of coupling breakage.

Further, since the rail cars can also send their status to the locomotive at the front, the train operator, for example, the engineer, can monitor the state of the rail cars and know at any given time the braking capabilities available.

In typical operation, the ECP brakes on a train are required to be operated in accordance with an ECP braking mode of operation governed by the Association of American Railroads (AAR)S-4200 standard braking requirements. In accordance with the S-4200 standard, the brakes of all of the rail cars of the train are controlled during operation of the train to the same percentage of braking during braking operations of the train.

For example, in accordance with the S-4200 standard, a processor based head end unit (HEU) in the locomotive can output a braking command on a trainline, e.g., a 30% braking command, which braking command is received by a processor of each rail car of the train communicatively coupled to the trainline. In response to receiving this braking command, the processor of each rail car causes the pneumatic brakes of the rail car to be set to the commanded value, in this example 30% of full braking. In this manner, the brakes of all of the rail cars of the train can be commanded to be set to the same percentage or level of braking at about the same time, thereby reducing and/or minimizing the levels of in-train forces on the couplers of the train that are used to connect the locomotive and the rail cars of the train that would appear on the couplers if the brakes of the rail cars were applied at different times.

In general, brakes of rail cars in a train enable deceleration, controlled acceleration (downhill), or keep the rail cars standing when parked. The functioning of proper brakes of rail cars in a train is essential and critical. Often times, a train including tens of cars travelling on a mainline track at a typical travelling speed can require over a mile (or kilometer) or two or more to come to a full stop. Braking of a train (comprised of a locomotive and attached rail cars) is initiated, typically, from the locomotive and the individual brakes on each of the rail cars typically respond to a signal in the form of ‘air pressure variance’ or ‘electronic initiation’ to trigger the braking systems to function as desired and bring the train to a stop or to slow it down, for example, as described above for the S-4200 standard. Braking efficiency can vary based on speed of the train, its momentum (based on the cargo it's carrying), external factors like temperature and wind, and urgency of braking. Today's braking systems, operating in accordance with the S-4200 standard, do one thing well, namely, apply the brakes in a manner that does not distinguish or have prejudice for different reasons for braking or the prevalent conditions in the train and its cargo.

Consequently, there is a need for an improved braking solution that overcome at least some of the deficiencies of the braking solutions of today.

### SUMMARY OF THE INVENTION

Generally, provided is an intelligent braking system and method for a train that has the ability to request one or more braking profiles from one or more groups of railcars within the train and further having the ability to alter the composition of the one or more groups of rail cars as well as the one or more braking profiles for each of the one or more groups of rail cars.

More specifically, provided are an improved system and method for intelligent or adaptive braking of one or more or all of the rail cars of a train that can, for each rail car of the train, optimize the braking force for each car brake unit based on one or more or any combination of the condition of the rail car, the cargo (or lack of cargo) on board the rail car, speed of travel, and/or any other physical force or condition that can influence the effectiveness of the overall braking of the train when initiated.

According to a preferred and non-limiting example, embodiment, or aspect, the adaptive braking system and method can determine dynamic behavior one or more rail cars of a train, the brakes of said one or more rail cars, or both during braking to, in a preferred and non-limiting example, embodiment, or aspect, desirably cause a stable braking profile safeguarding the train and its cargo and any wayside installation or entity.

In a preferred and non-limiting example, embodiment, or aspect, the train can have electronically controlled braking, such as ECP braking described above, that can be modified in the manner discussed herein to operate outside of the S-4200 standard. In a preferred and non-limiting example, embodiment, or aspect, the train can have conventional pneumatic (non-electronically triggered) controlled braking that can be modified and used accordingly. In a preferred and non-limiting example, embodiment, or aspect, a human machine interface (HMI) can be provided for the engineer (or train operator) to enter a speed, or a location, or both that can define the desired train braking to be achieved by the system and method for intelligent or adaptive braking described herein.

Today's S-4200 compliant braking systems are non-discriminative. Namely, during braking of the train, the brakes of each rail car are commanded to be set to the same percentage of braking. In response to such brake commands, and except for minor pneumatic and mechanical variations between the pneumatic brakes of each rail car, in response to a train brake command the brakes of each rail car respond in the same manner, i.e., the brakes of each rail car are set to the same percentage of braking as the brakes of each other rail car. In a preferred and non-limiting example, embodiment, or aspect, the system and method for intelligent or adaptive braking described herein can selectively set the brakes of each rail car of a train to a percentage of braking selected for the rail car, which percentage of braking can vary between 0% braking and 100% braking (or 120%—emergency braking), and which percentage of braking can be the same or different than the percentage of braking of each other rail car of the train. In a preferred and non-limiting example, embodiment, or aspect, the system and method for intelligent or adaptive braking described herein can cause the brakes of each rail car to be set to a percentage of braking that can optimize braking efficiency of the entire train.

In a preferred and non-limiting example, embodiment, or aspect, the system and method for intelligent or adaptive braking described herein can reduce or eliminate the role of the engineer (or train operator) by automating the capabilities on-board the locomotive. In a preferred and non-limiting example, embodiment, or aspect, a train operator may determine, via a map (for example), a desired location where the train is expected to slow down to a particular speed or come to a full stop and can input this information into a locomotive head-end unit (HEU). In response to this input, the system and method for intelligent or adaptive braking described herein can cause the brakes of each rail car to be set to a percentage of braking specifically selected for said rail car to achieve the particular speed or stop at the desired location, desirably without further train operator input to achieve the particular speed or stop at the desired location.

Current locomotive HMIs allow control of the brake system, but not entry of the desired percentage of braking specifically selected for each rail car. Other systems calculate a desired braking outcome and either “coach” the engineer how to enter controls to achieve that outcome, or may even actively couple to the controls to achieve that outcome. In a preferred and non-limiting example, embodiment, or aspect, the system and method for intelligent or adaptive braking described herein allows the train operator to determine and input the desired outcome, and then let the system calculate and execute the required braking to achieve the desired outcome.

In a preferred and non-limiting example, embodiment, or aspect, overall braking of a train and, more particularly, the selective control and setting of the brakes of each rail car of the train independent of the control and setting of the brakes of each other rail car of the train can be determined or calculated by the HEU. In a preferred and non-limiting example, embodiment, or aspect, such calculation can increase the longevity of the braking components by reducing wear on the brake shoes or pads and reduce stress on the overall braking system of each rail car. This can result in improved cost efficiencies, and improved safety for the train, the cargo, the crew and anyone/anything in the vicinity of the train traveling, for example, on a mainline track. In a preferred and non-limiting example, embodiment, or aspect, the system and method for intelligent or adaptive braking described herein may not require the train operator to mentally determine brake system parameters required to achieve the desired braking outcomes.

In a preferred and non-limiting example, embodiment, or aspect, the system and method for intelligent or adaptive braking can have one or more sensors for sensing braking elements and/or other operational aspects or features of one or more of the rail cars, which one or more sensors can provide the HEU with data that the HEU can use to determine the brakes on each car that need to be triggered, when, and how much braking force needs to be exerted the brakes on the car when the train is travelling on a mainline track.

Historically, a train operator inspects the locomotive before and during operation, as well as checks speed, air pressure, battery, and other systems of the train while travelling on a mainline track. In a preferred and non-limiting example, embodiment, or aspect, it is envisioned that, with the help of sensors on the rail cars, automated and intelligent decision making regarding setting the brakes of each rail car to a percentage of braking specifically selected for said rail car to achieve a particular speed or stop of the entire train at the desired location, a locomotive having the system and method for intelligent or adaptive braking described herein can reduce or eliminate the decision making role of the train operator(s) (e.g., a locomotive driver and engineer) regarding such setting of the brakes.

In a preferred and non-limiting example, embodiment, or aspect, a train having, for example, ten rail cars can be controlled to optimize braking based on the HEUs understanding of dynamic behavior of or more of the rail cars, acquired, for example, from sensors on one or more of all of said cars, having a determined weight of cargo. In a preferred and non-limiting example, embodiment, or aspect, the HEU can determine a desired, desirably optimal, braking of one or more rail cars of the train based on the number of rail cars, the type of cargo being transported, and the sequence of coupling of the rail cars. Based on this information, the HEU can compute a desired, desirably optimal, braking sequence or braking scenario that includes determining which brakes of one or more or all of the rail cars to trigger for braking and the braking percentage the brakes of each such rail car exerts to desirably provide for smooth and safe braking of the entire train.

In a preferred and non-limiting example, embodiment, or aspect, the system and method for intelligent or adaptive braking can compute the percentage of braking not for each rail car individually, but for a group or subset of cars. For example, in a train with ten rail cars, the system and method for intelligent or adaptive braking can determine percentages of braking for the group of rail cars 1, 2, 3, 4, 5 and, at another time, determine percentages of braking for the group of rail cars 6, 7, 8, 9, 10, and so on, where the brakes of each rail car of each group can be set to a percentage of braking selected for the rail car, which percentage of braking can vary between 0% braking and 120% (emergency) braking, and which percentage of braking can be the same or different than the percentage of braking of each other rail car of the group. In a preferred and non-limiting example, embodiment, or aspect, it is also envisioned that normally deployed pneumatic (non-electronically triggered) braking system may also be modified and used accordingly.

In a preferred and non-limiting example, embodiment, or aspect, the system and method for intelligent or adaptive braking can determine the braking force to be applied by the brakes of each rail car based not only on the dynamic forces acting on the car (because of the load, the speed, and the environmental factors) but also based on the condition of the brake shoes, more particularly the amount of wear on the brake shoes or pads. In a preferred and non-limiting example, embodiment, or aspect, this can mean that the system and method for intelligent or adaptive braking can set the percentage of braking of the brakes on each rail car of the train independently of the setting the percentage of braking of the brakes on each other rail car of the train in a manner to extend the life of brake shoes or pads.

In a preferred and non-limiting example, embodiment, or aspect, the system and method for intelligent or adaptive braking can determine the braking percentage to be applied by one or more of the cars based on a condition one or more wheels of the rail car and any present imperfections of said wheel(s).

In a preferred and non-limiting example, embodiment, or aspect, each rail car can have one or more sensors that can measure the weight of each car, and a central braking component, e.g., the HEU, can utilize information about the cargo in each car, speed of travel of the train, and prevalent environment conditions to determine a unique percentage of braking for each rail car. In a preferred and non-limiting example, embodiment, or aspect, the brakes of each car will receive a percent braking command specific to that car that will allow synchronous braking in all the railcars, with or without the application of uniform braking forces, to slow the train and/or to bring the train to a safe stop in view of the prevalent environment conditions. Environment conditions can include data regarding any weather condition, such as, for example, temperature, pressure, moisture, wind conditions, seasonal information that may be indicative of extreme travel like snow, ice, sleet, leaves (during fall season), etc.

In a preferred and non-limiting example, embodiment, or aspect, the system and method for intelligent or adaptive braking can calculate the required brake application necessary to achieve an operational outcome upon train operator entry of a desired speed, or a desired speed and location to achieve that speed.

Further preferred and non-limiting embodiments or aspects are set forth in the following numbered clauses.

Clause 1: A method of braking a plurality of rail cars of a train while travelling or moving on a mainline track that includes a locomotive processor onboard a locomotive of the train in communication with a rail car processor of each rail car of the train, the method comprising: (a) the locomotive processor providing to each rail car processor of a first subset of the rail cars a unique braking command that is independent of the braking command provided to each other rail car processor of the first subset of rail cars, wherein each braking command includes a level or percentage of braking the brakes of the rail car are to assume; and (b) in response to the braking command provided to each rail car processor of the first subset of the rail cars in step (a), the rail car processor causing the brakes of the rail car to assume the level or percentage of braking included in the unique braking command provided to the rail car processor.

Clause 2: The method of clause 1, wherein the unique braking command provided to each rail car processor of the first subset of the rail cars can be based on data regarding the rail car, the train, or both provided to the locomotive processor.

Clause 3: The method of clause 1 or 2, wherein the data can include predicted or actual data regarding one or more of the following: a health of the braking system of one or more of the rail cars of the train; one or more environmental conditions in a vicinity of the train; dynamic behavior of one or more rail cars of the train while travelling or moving or during braking; topology of a track between a present location and a future location of the train; and a load carried by one or more of the rail cars.

Clause 4: The method of any one of clauses 1-3, wherein the data regarding the health of the braking system can include one or more of the following: actual or estimated wear or life of a brake shoe/pad; actual or estimated wear of the brake shoe/pad based on the load carried by one or more of the rail cars of the train; and actual or estimated wear of the brake shoe/pad based on G forces of one or more rail cars of the train while travelling or moving.

Clause 5: The method of any one of clauses 1-4, wherein the actual or estimated wear or life of a brake shoe/pad can be determined from optical data of the brake shoe/pad acquired by a camera or based on an output of an electrical/electronic circuit detecting the useable brake material or amount of useable brake material.

Clause 6: The method of any one of clauses 1-5, wherein the one or more environmental conditions can include one or more of the following: temperature, wind speed, wind direction, humidity, the presence or absence of ice or snow on the track upon which the train is travelling, and precipitation.

Clause 7: The method of any one of clauses 1-6, wherein the data regarding the one or more environmental conditions can be received wirelessly by the locomotive processor from a source remote from the train.

Clause 8: The method of any one of clauses 1-7, wherein the data regarding the dynamic behavior of one or more rail cars of the train while travelling or moving or during braking can include one or more of the following: a force on a coupler; rate of change of velocity (acceleration or deceleration) of the train; G forces of one or more rail cars of the train; pitch or roll of one or more rail cars of the train; and track adhesion is determined based on a difference between a linear speed of a wheel of at least one rail car and a speed of the train.

Clause 9: The method of any one of clauses 1-8, wherein the data regarding topology can include one or more of the following: track gradient; track curvature; and track elevation.

Clause 10: The method of any one of clauses 1-9, wherein the load carried by one of the rail cars of the train can be determined by one or more load cells mounted to the rail car.

Clause 11: The method of any one of clauses 1-10, further including, following step (b): (c) the locomotive processor can provide to each rail car processor of a second subset of the rail cars a unique braking command that is independent of braking command provided to each other rail car processor of the second subset of rail cars; and (d) in response to the braking command provided to each rail car processor of the second subset of the rail cars in step (c), the rail car processor can cause the brakes of the rail car to assume the level or percentage of braking included in the unique braking command provided to the rail car processor, wherein the first and second subsets of rail cars are different.

Clause 12: A method of braking a plurality of rail cars of a train while travelling or moving on a mainline track, wherein each rail car includes a rail car processor that is operative for controlling the brakes of the rail car, the method comprising: (a) each rail car processor of a first subset of the rail cars receiving a braking command prepared exclusively for the rail car processor; and (b) in response to step (a), each rail car processor of the first subset of the rail cars causing the brakes of its rail car to assume a level or percentage of braking included in the braking command received by the rail car processor in step (a).

Clause 13: The method of clause 12, further including: (c), following step (b), each rail car processor of a second subset of the rail cars can receive a braking command prepared exclusively for the rail car processor; and, (d) in response to step (c), each rail car processor of the second subset of the rail cars can cause the brakes of its rail car to assume a level or percentage of braking included in the braking command received by the rail car processor in step (c), wherein the first and second subsets of rail cars can be different.

Clause 14: A method of braking a plurality of rail cars of a train while travelling or moving on a mainline track, comprising: (a) a locomotive processor providing to each rail car processor of a first subset of the rail cars a braking command that is prepared exclusively for the rail car processor; (b) each rail car processor of the first subset of rail cars receiving the braking command provided to the rail car processor in step (a); (c) each rail car processor of the first subset of rail cars processing the braking command received in step (b); and (d) each rail car processor of the first subset of rail cars setting the brakes of its rail car to a level or percentage of braking included in the braking command processed in step (c) for the rail car processor, whereupon the brakes of each rail car of the first subset of rail cars are set to the same or a different percentage of braking than the brakes any other rail car of the first subset of rail cars.

Clause 15: The method of clause 14, further comprising, following step (d): (e) the locomotive processor can provide to each rail car processor of a second subset of the rail cars a braking command that is prepared exclusively for the rail car processor; (f) each rail car processor of the second subset of rail cars can receive the braking command provided to the rail car processor in step (e); (g) each rail car processor of the second subset of rail cars can process the braking command received in step (f); and (h) each rail car processor of the second subset of rail cars can set the brakes of its rail car to a level or percentage of braking included in the braking command processed in step (g) for the rail car processor, whereupon the brakes of each rail car of the second subset of rail cars can be set to the same or a different percentage of braking than the brakes of any other rail car of the second subset of rail cars, wherein the first and second subsets of rail cars can be different.

Clause 16: The method of clause 14 or 15, wherein each subset of rail cars can include one or more rail cars.

Clause 17: A system for controlling braking of a plurality of rail cars of a train while travelling or moving on a mainline track, the system comprising: a rail car processor associated with each rail car, wherein each rail car processor, operating under the control of a rail car software program, is operative, in response to a unique braking command received by the rail car processor, to set brake(s) of the rail car to a level or percentage commanded by the braking command; a communication network linking the rail car processors of the plurality of rail cars; and a control processor in communication with each rail car processor via the communication network, wherein the control processor, operating under the control of a control software program, is operative for transmitting to each rail car processor the unique braking command prepared exclusively for the rail car processor and which causes the rail car processor to set the brake(s) of the rail car to a level or percentage of braking associated with the unique braking command that is the same or different than a level or percentage of braking of the brake(s) of each other rail car are set.

Clause 18: The system of clause 17, wherein: each rail car processor can include a data address that is unique to said rail car processor; and the unique braking command provided to each rail car processor can be addressed to the data address of the rail car processor.

Clause 19: A method of braking a plurality of rail cars of a train while travelling or moving on a mainline track, comprising: (a) issuing first and second brake commands to first and second rail cars, wherein the first brake command includes a first level or percentage of braking of the brake(s) of the first rail car, wherein the second brake command includes a second, different level or percentage of braking of the brake(s) of the second rail car; and (b) in response to step (a), setting the brake(s) of the first and second rail cars of the plurality of the rail cars to the respective first and second levels or percentages of braking included in the first and second brake commands.

Clause 20: The method of claim 19, further including, following step (b): (c) issuing third and fourth brake commands to the first and second rail cars, wherein the third brake command can include a third level or percentage of braking of the brake(s) of the first rail car, wherein the fourth brake command can include a fourth level or percentage of braking of the brake(s) of the second rail car that is different than the third level or percentage of braking; and (d), in response to step (c), setting the brake(s) of the first and second rail cars of the plurality of the rail cars to the respective third and fourth levels or percentages of braking included in the third and fourth brake commands. The third and fourth levels or percentages of braking can be different than the first and second levels or percentages of braking. Each of the first through fourth levels or percentages of braking can be different from each other.

Clause 21: A method for segmented rail car braking of one or more rail cars of a train while travelling or moving on a mainline track, each rail car equipped with an electronically controllable braking system, the method comprising: (a) identifying one or more groups of one or more rail cars of the train for purposes of braking; and (b) commanding each of the one or more groups of one or more rail cars to brake using a custom braking profile unique to that group in order to achieve a desired overall braking response from the train.

Clause 22: The method of clause 21, further comprising defining the custom braking profile for each of the one or more groups of the one or more rail cars based on at least one dynamic behavior of each of the rail cars in each of the one or more groups. In a preferred and non-limiting example, embodiment, or aspect, the dynamic behavior of each rail car can include one or more of the following: rate of change of velocity, G force, pitch or roll behavior, and force on at least one coupler.

Clause 23. The method of clause 21 or 22, further comprising defining the custom braking profile to result in a specific dynamic behavior of each of the rail cars in each of the one or more groups.

Clause 24. The method of any one of clauses 21-23, further comprising defining the custom braking profile for each of the one or more groups of one or more rail cars based on topology of a track upon which the train is traveling or moving from a present location to a future location located further down the track. In a preferred and non-limiting example, embodiment, or aspect, the topology of the track can include positive track gradient, negative track gradient, track curvature, and track elevation.

Clause 25: The method of any one of clauses 21-24, further comprising defining the custom braking profile for each of the one or more groups of one or more rail cars based on a health of a braking system on each of the one or more rail cars in the train. In a preferred and non-limiting example, embodiment, or aspect, the health of the braking system on each car can include wear on the brake discs, wear on the brake shoes, estimated remaining life of the brake discs/shoes, estimated wear based on the cargo carried therein, and estimated wear based on the G forces exerted during the travel.

Clause 26: The method of any one of clauses 21-25, further comprising dynamically altering a composition of rail cars in each of the one or more groups based on dynamic response of the train during braking. In a preferred and non-limiting example, embodiment, or aspect, each group may be consecutive rail cars, or discrete rail cars. In a preferred and non-limiting example, embodiment, or aspect, the selection of each group may be made based on desired overall dynamic response of the group as a whole rather than individual rail cars. In a preferred and non-limiting example, embodiment, or aspect, the selection of each group may also be based on individual dynamic response of each rail car.

Clause 27: The method of any one of clauses 21-26, wherein steps (a) and (b) are based on a future location of the train selected by a train operator.

Clause 28: The method of any one of clauses 21-27, further comprising selecting the future location based on input to a processor, e.g., from a console onboard the train or via a wireless device remote from the train. In a preferred and non-limiting example, embodiment, or aspect, the amount of braking, the number of groups and the number of rail cars in each group to accomplish said amount of braking can be determined by the HEU based on a train speed profile, or distance to braking, or distance to stop based on the selected future location.

Clause 29: The method of any one of clauses 21-28, further comprising defining the custom braking profile for each of the one or more groups of one or more rail cars based on environmental conditions in a vicinity of at least one or more rail cars of the train. In a preferred and non-limiting example, embodiment, or aspect, the environmental conditions can include one or more of the following: percent humidity; wind direction; wind speed; the presence (or absence) of rain, ice, or other conditions that can affect traction; track adhesion; and visibility.

Clause 30: The method of any one of clauses 21-29, further comprising defining the custom braking profile for each of the one or more groups of one or more rail cars based on physical characteristics of the train. In a preferred and non-limiting example, embodiment, or aspect, the physical characteristics of the train can include one or more of the following for one or more or all of the cars of the train or of the train as a whole: acceleration, deceleration, G forces, pitch or roll behavior, coupler forces, in-car forces, wheel-slip, and wheel-spin.

Clause 31. The method of any one of clauses 21-30, further comprising dynamically altering the custom braking profile for each of the rail cars in each of the one or more groups in about real-time.

Clause 32. The method of any one of clauses 21-31, further comprising selecting the future location based on input to a navigation equipment onboard the train. In a preferred and non-limiting example, embodiment, or aspect, a train operator can enter the future location, e.g., a destination point, from a GPS console/electronic map.

Clause 33. The method of any one of clauses 21-32, further comprising selecting the future location via a wayside dispatching system.

Clause 34: A method for braking a train comprising plurality of railcars, the method comprising: identifying a group of one or more railcars that would participate in the braking; providing a specific percentage braking command for each of the one or more railcars; and monitoring braking performance delivered by the braking of the one or more railcars.

Clause 35: The method of clause 34, further comprising, performing at least one of the following: altering the specific percentage braking command for each of the one or more railcars participating in the braking; and altering the composition of the group of the one or more railcars by adding a new railcar to the group to participate in the braking, removing an existing railcar from the group of the one or more railcars participating in the braking, or both.

Clause 36: The method of clause 34 or 35, further comprising: identifying a second group of one or more railcars that would participate in the braking; providing a specific percentage braking command for each of the one or more railcars of the second group; and monitoring braking performance delivered by the braking of the one or more railcars of the second group.

Clause 37: The method of any one of clause 34-36, further comprising performing at least one of the following: altering the specific percentage braking command for each of the one or more railcars of the second group; and altering the composition of the second group of the one or more railcars by adding new railcars to the group to participate in the braking, removing an existing railcar from the group of the one or more railcars participating in the braking, or both.

In a preferred and non-limiting example, embodiment, or aspect, the amount of wear of each of one or more brake pads or shoes of a rail car may be visually determined using, for example, a camera that can observe the amount of material left on the brake pad or shoe that can be used. The output of the camera can be processed by the HEU. In a preferred and non-limiting example, embodiment, or aspect, the usable brake material of the brake pad or shoe may be a first color that can be detected by the camera. As the usable brake material wears off, whereupon the brake pad or shoe the requires replacement, the brake material may be a second color. As the color changes, the HEU could know the braking performance may be limited and can alter, e.g., reduce, the percentage of braking provided by the rail car.

In a preferred and non-limiting example, embodiment, or aspect, the brake pad or shoe may have multiple colors that can represent more than just two levels of indication of its status. In a preferred and non-limiting example, embodiment, or aspect, the brake pad or shoe may have colors that represent ‘very good’, ‘satisfactory’, ‘needs attention’ and/or ‘needs immediate replacement’ states.

In a preferred and non-limiting example, embodiment, or aspect, the brake pad or shoe may include embedded electric/electronic circuitry that can either ‘conduct’ or ‘block’ an electrical signal, e.g., voltage or current. In a preferred and non-limiting example, embodiment, or aspect, continuity of the electrical signal may indicate stable braking material and performance, whereas absence of the electrical signal may indicate a break in the electrical path and therefore a wearing out of the brakes. Multiple electrical paths may be provided to detect different levels of degradation of the brake pad or shoe.

In a preferred and non-limiting example, embodiment, or aspect, an improperly configured or misaligned braking system may result in adverse forces on a wheel and/or brake frame of the rail car or braking system. One or more sensors may be provided to detects such adverse forces to indirectly draw an inference of braking system performance.

Weather/environmental conditions may be measured at multiple levels. In a preferred and non-limiting example, embodiment, or aspect, the HEU can be pre-programmed with estimated weather conditions at various times of the day for the entire journey along the entire mainline track. This weather data can be gathered from weather sources in any manner, e.g., manually, electronically, e.g., via a wireless network, and entered into the HEU.

In a preferred and non-limiting example, embodiment, or aspect, the HEU can be programmed to be updated with local weather events and notifications from the local sources as it travels on the mainline track through the area. These local weather events and notifications can include alerts, such as, for example, flash flood warnings that get beamed to cellphones in a vicinity during heavy rains.

In a preferred and non-limiting example, embodiment, or aspect, the HEU can directly receive information about local weather or climatic conditions, including wind patterns, moisture levels, etc. and correlate that information with navigation/terrain information to determine the impact of the weather/climatic conditions on the train and the percentage of braking to be provided by each rail car. In a preferred and non-limiting example, embodiment, or aspect, the train can have means known in the art to measure temperature, wind speed, wind direction, humidity, etc. The HEU can receive the output of such means and can set the percentage of braking of each rail car individually from the percentage of braking of each other rail car from 0% to 100% (or 120% emergency braking) based on said output.

Wheel-rail adhesion must be sufficient to fulfil safety and punctuality requirements. In a preferred and non-limiting example, embodiment, or aspect, wheel-rail adhesion is desired during accelerating or braking and less or no wheel-rail adhesion is desired when coasting. During braking, low adhesion can extend the braking distance i.e., increase the distance to reach a particular lower speed, all the way to full stop. Too much or too less wheel-rail adhesion can adversely affect the train's journey. Further complicating it is the fact that the “proper” wheel-rail adhesion may not always be a fixed value. It can change with changing environmental conditions, geographical location, behavior of the rail cars during braking, the type and nature of cargo being hauled, etc.

While traveling or moving on a mainline track, low wheel-rail adhesion can reduce acceleration and extend braking distance, possibly disrupting the travel schedule of the train and possibly other trains that travel on the same track. In a preferred and non-limiting example, embodiment, or aspect, wheel-rail adhesion may be kept low to minimize energy consumption. If the wheel-rail adhesion is too high, the wheels and rails can be subject to excessive shear stress, leading to accelerated wear and surface fatigue. As the wheel-rail contact is an open system, the wheel-rail adhesion can be affected by contaminants. Contaminants, which refers to foreign substances applied both intentionally and unintentionally to the wheel-rail interface, can make wheel-rail adhesion either too high or too low and difficult to predict. The prediction of wheel-rail adhesion can be important not only to railway operation but also to the simulation of multi-body vehicle dynamics.

Magnetic sensors are solid state devices that can be used for sensing position, velocity or directional movement. One of the main uses of magnetic sensors is in automotive systems for the sensing of position, distance and speed. For example, the angular position of the crank shaft for the firing angle of the spark plugs, the position of the car seats and seat belts for air-bag control or wheel speed detection for the anti-lock braking system (ABS). Magnetic sensors can respond to a wide range of positive and negative magnetic fields in a variety of different applications and one type of magnet sensor whose output signal is a function of magnetic field density around it is called the Hall Effect Sensor.

Hall Effect Sensors are devices which are activated by an external magnetic field. A magnetic field has two important characteristics, namely, flux density, and polarity (North and South Poles). The output signal from a Hall effect sensor is the function of magnetic field density around the device. When the magnetic flux density around the sensor exceeds a certain pre-set threshold, the sensor detects it and generates an output voltage called the Hall Voltage, VH. Hall Effect Sensors are basically comprised of a thin piece of rectangular p-type semiconductor material such as gallium arsenide (GaAs), indium antimonide (InSb) or indium arsenide (InAs) having a continuous current passing therethrough. When the device is placed within a magnetic field, the magnetic flux lines exert a force on the semiconductor material which deflects the charge carriers, electrons and holes, to either side of the semiconductor piece. This movement of charge carriers is a result of the magnetic force the charge carriers experience passing through the semiconductor material. As these electrons and holes move side wards a potential difference is produced between the two sides of the semiconductor material by the build-up of these charge carriers. Then the movement of electrons through the semiconductor material is affected by the presence of an external magnetic field which is at right angles to it and this effect is greater in a flat rectangular shaped material. The effect of generating a measurable voltage by using a magnetic field is called the Hall Effect after Edwin Hall who discovered it back in the 1870's with the basic physical principle underlying the Hall effect being Lorentz force. To generate a potential difference across the device the magnetic flux lines must be perpendicular, (90°) to the flow of current and be of the correct polarity, generally a south pole.

The Hall effect provides information regarding the type of magnetic pole and magnitude of the magnetic field. For example, a south pole would cause the device to produce a voltage output while a north pole would have no effect. Generally, Hall Effect sensors and switches are designed to be in the “OFF”, (open circuit condition) when there is no magnetic field present. They only turn “ON”, (closed circuit condition) when subjected to a magnetic field of sufficient strength and polarity. See e.g., Wolfs et al., “Wheel Speed, Wheel Slip and True Ground Speed Detection Options for Brake Vans”, Centre for Railway Engineering, CRE-R 131 ELEC-2/05, Sep. 21, 2005, which is incorporated herein by reference.

Physical measurements of a rail car load may be done at a loading dock. Since the type and quantity of cargo onboard each rail may be known in advance, it can be one of the easier things to determine. In a preferred and non-limiting example, embodiment, or aspect, the rail car may have one or more embedded load cells that can aid in the automatic determination of the rail car load. The output(s) of the one or more embedded load cells can be provided to the HEU which can determined from said output(s) if the rail car is empty, partially full, completely full, or overloaded. In a preferred and non-limiting example, embodiment, or aspect, the output(s) the one or more embedded load cells can be used by the HEU to determine dynamic behavior of cargo in the rail car at various speeds and terrain and inclines and also when subjected to braking forces. How a rail car loaded with solid cargo reacts will be different from how the rail car loaded with a liquid cargo reacts.

Rail car weight can range from about 60,000 lbs. (27,215 Kg) empty to about 265,000 lbs. (120,200 Kg) fully laden. The load on each rail car can be measured mechanically using the amount of compression of the springs in the trucks (bogies). For large unit trains, such as trains carrying coal or any kind of ore (using open top rail cars), the tendency is to load each rail car to full load at best, and an overload at worst. Braking systems for rail cars are designed to operate at about peak design load with a +/− safety limit. The behavior of rail cars that are overladen, particularly when travelling at higher speeds on a decline (travelling downhill), can be unpredictable.

In a preferred and non-limiting example, embodiment, or aspect, the HEU can monitor a roll behavior of a rail car via one or more load cells sensing forces on the side roller bearing and the side bearing cage of a brake assembly. In a preferred and non-limiting example, embodiment, or aspect, the percent loading on one or more rail cars may be monitored, e.g., optically or via one or more load cells, by the amount of compression of one or more springs of the rail car between a typically minimum and a typical max and an overload threshold. In a preferred and non-limiting example, embodiment, or aspect, by monitoring the percent compression between the truck (bogie) at the front and the back, pitch conditions of the rail car can be determined. In a preferred and non-limiting example, embodiment, or aspect, accelerometers disposed on the rail car may be used to indicate the rate of change and differentiate between a gradual change and an abrupt change.

In the U.S., regulations of Federal Railroad Administration of the U.S. Department of Transportation require that the systems of all rail cars of a train operate as expected during normal operations, e.g., while travelling between locations on a mainline track. In a preferred and non-limiting example, embodiment, or aspect, the rail cars of a train can be segmented for the purposes of braking. In a preferred and non-limiting example, embodiment, or aspect, only a select grouping of one or more rail cars and one or more such groups can be used for train braking, while the rest of the rail cars can be operated with their brakes off or not applied.

In a preferred and non-limiting example, embodiment, or aspect, all of the rail cars can be used for braking, with the brakes of some of the rail cars commanded to be set to participate more towards the train braking while some of the other rail cars can be commanded to be set to participate less towards the train braking. In this preferred and non-limiting example, embodiment, or aspect, the rail cars that can be commanded to be set to participate less towards the train braking may contribute to braking but with a braking force that may be less than the braking force that would be applied under the S-4200 standard. In a preferred and non-limiting example, embodiment, or aspect, the HEU determines the desired braking effort for the entire train and then delivers desired braking effort using a subset of rail cars.

When the brakes of a rail car provide more braking that necessary, e.g., the wheels lock up, it can result in wheel flats. A wheel flat condition is when the running wheels abrade against the steel rail in response to wheel lock up during braking. This results in a wheel flat i.e., a flat surface on the circular surface of the wheels. Apart from wheel flats, the locking of the wheels also results in increased local temperature around the wheel flats.

As the train continues travelling or moving on the mainline track, the wheel flats, which will repeatedly contact with the steel rail during each rotation, will increase the amount of shock and vibration experienced by the rail car. Such effects may be measured on the rail car truck (or bogie) and also on the rail car and perhaps even on the cargo carried onboard the rail car. The intensity of the shock and vibration will directly correspond to the extent of the wheel flat or the amount of flatness of the steel wheel. Therefore, one or more sensors (e.g., load cells) measuring shock and vibration can be provided in a rail car to detect a sudden increase in such measurement which can be indicative of a wheel flat. In a preferred and non-limiting example, embodiment, or aspect, the HEU can processes the output of such sensor(s) and can determine therefrom if a wheel on a rail car may have a wheel flat and can adjust (e.g., reduce) a percentage of braking provided to the train by said rail car, e.g., to avoid exasperating the wheel flat condition and/or to avoid fluctuations in the percentage of braking due to the wheel flat repeatedly contacting the rail during braking.

In a typical rail car, each brake beam includes two brake heads, each holding a brake shoe. As the brake shoes push against the wheels, there is resultant strain in the brake beam. Using one or more sensors (e.g., load cells) mounted to a brake beam, the degree and orientation of the strain can provide the HEU with a direct indication of the braking force being applied to the wheel.

Electrodynamic Energy Harvesting (EEH) operates under Faraday's law of induction. In a preferred and non-limiting example, embodiment, or aspect, energy is created when a magnetic field passes by an electrically conductive wire or coil. This energy can be captured and converted into a usable current, e.g., in the milli-watt range, which can be used to power low-power devices, such as, for example, sensors and other electronic circuitry, which may be present on one or more rail cars and/or the locomotive of a train, which circuitry may have no connection to a conventional power source, e.g., a battery or a generator.

For many of these devices, the 10 mW range may be about the power needed to operate smart-sensors, multi-sensors, nodes and similar devices. Moreover, widely available motion sources of a train can be to drive EEH devices. The most dominant of these excitation sources can include vibration, liquid or air flow, and rotation. Of these sources, for a rail car, vibration offers the greatest potential due to an unlimited amount of excitation sources such as mechanical and environmental vibration, human motion, and wind.

However, a drawback of EEH is that the energy generated is only about 4-800 microwatts per cm³, which is not near that ideal “10 mW” goal. Initial uses for vibration based EEH involve low-power, non-continuous applications such as television remote controls.

In comparison, flow-based electrodynamic energy harvesting typically uses the electrodynamic effect to act as a micro-generator, where the device captures the flow of wind or liquid causing an internal motor to spin and generate energy. The drawback is that most of these harvesters are relatively bulky. The benefit is that the amount of available power generated can be significant, up to 540 mW at 25 liters per minute.

Finally, there is rotation-based EEH, which is growing in popularity due to ability to offer high and continuous amounts of motion. Common areas where one might use this form of EEH include cooling fans, internal gears, ventilation systems and existing engines. As for power availability, models of rotation-based EEH have been known to produce above 60 mW of continuous output, provided there is motion. Because of this, there here are numerous theoretical applications for EEH in a train environment as well as the Internet of Things (IoT) which is defined as is the inter-networking of physical devices, vehicles (also referred to as “connected devices” and “smart devices”), buildings, and other items embedded with electronics, software, sensors, actuators, and network connectivity which enable these objects to collect and exchange data. The IoT allows objects to be sensed or controlled remotely across existing network infrastructure, creating opportunities for more direct integration of the physical world into computer-based systems, and resulting in improved efficiency, accuracy and economic benefit in addition to reduced human intervention. When IoT is augmented with sensors and actuators, the technology becomes an instance of the more general class of cyber-physical systems, which also encompasses technologies such as smart grids, virtual power plants, smart homes, intelligent transportation and smart cities. Each thing is uniquely identifiable through its embedded computing system but is able to interoperate within the existing Internet infrastructure.

EEH can be broad band, useful in rail cars, for example, where there is plenty of energy that can be harvested from motion of the rail car. Narrow band EEH, which can be more efficient, can be used for more precise and predictable vibration of, for example, electric motors. Information regarding EEH can be found at: http://www.energyharyestingjournal.com/articles/1274/perpetuum-a-vibration-harve sting-company.

According to preferred and non-limiting example, embodiment, or aspect, assume a train travelling from location A to location B. Before the train departs from A, accurate information will be known about the following: where is the train headed; how many rail cars; cargo on each of the rail cars; estimated duration of travel to B; existing conditions (traffic related, weather related, work related); existing health condition of the rail cars (i.e., things like brake shoe health, brake system health, rail car health, coupler health). In a preferred and non-limiting example, embodiment, or aspect, this information can be gathered using (IoT).

Prior to the present invention, the amount of braking applied on the train is based on the train operator discretion. No two train operators have the same belief in terms of how much braking to apply, when, etc. It's more an art than a science.

In a preferred and non-limiting example, embodiment, or aspect, in accordance with the present invention, the train operator can indicate to the ‘adaptive braking system’ via a human machine interface (HMI) information such as: what is the desired braking requirement (whether to slow down or coast or accelerate); and when is the desired braking condition expected to be reached (e.g., what is the desired speed at a location C, between locations A and B). The ‘adaptive braking system’ can then determine how the total braking requirement of the train can be delivered via braking of a subset of rail cars based on factors such as, without limitation: the health of each brake on each rail car; how much of the brake's behavior will be impacted by the type/amount of cargo being hauled in each rail car; and/or one or more dynamic characteristics of the moving rail car.

In the U.S., regulations require at least 85% of the rail cars in a train to have operating/fully functioning brakes in order for a journey to be initiated. Of course, the ideal condition is that all (100%) of the brakes on all of rail cars are functioning and operational.

In a preferred and non-limiting example, embodiment, or aspect, the adaptive braking system determines the braking solution for the entire train rather than a braking solution for each rail car. In a preferred and non-limiting example, embodiment, or aspect, the adaptive braking system can monitor the dynamic behavior of each rail car and that of the entire train and have the ability to alter an initial group (there can be more than one group) of one or more rail cars with the goal of causing the most stable braking solution for the train such that the desired speed is achieved when the train reaches the desired location B.

In a preferred and non-limiting example, embodiment, or aspect, the adaptive braking system can initially allocate a subset of rail cars (continuous or discrete/distributed) to participate in the braking solution and then alter the subset of rail cars by adding/removing the number of participating rail cars, desirably in about real-time, and dynamically altering the percent braking required from each of the participating rail cars in about real-time. Other considerations, like health, environment, etc., are merely parameters that are monitored to aid in the adding/removing and altering described above.

In a preferred and non-limiting example, embodiment, or aspect, the adaptive braking system may determine the gradient of the track as the train proceeds from A to B and determine the braking solution considering the positive impact of gravity (if travel is uphill) or the negative impact of gravity (if travel is downhill).

In a preferred and non-limiting example, embodiment, or aspect, the adaptive braking system may determine the braking solution based on the adhesion of the wheels to the track (or the lack of it).

In a preferred and non-limiting example, embodiment, or aspect, the adaptive braking system may determine the braking solution based on weather conditions prevalent in the vicinity of the train based on actual measurement from equipment on the train or remotely via observation from satellites and radar (Doppler, etc.).

In a preferred and non-limiting example, embodiment, or aspect, the adaptive braking system may determine the braking solution based on curvature of the rail track (super elevation).

In a preferred and non-limiting example, embodiment, or aspect, the adaptive braking system may determine the braking solution by requiring all the rail cars to participate in the braking in case of an emergency condition that requires 120% braking.

In a preferred and non-limiting example, embodiment, or aspect, in a train having 1 locomotive and 10 rail cars (1-10), the initial braking, based on above criteria, may involve the braking of rail cars 1, 2, 3, 8, 9, and 10. Upon braking, and based on real-time monitoring of dynamic behavior of the train and health of individual subsystem on one or more the rail cars and locomotive, a revised dynamic braking may alter the configuration of the participating rail cars by now requiring rail cars 1, 2, 4, 5, 7, 9 and 10 (3, 8 got dropped while 5, 7 got added).

In a preferred and non-limiting example, embodiment, or aspect, if by a certain threshold (time or distance or behavior or combinations), the adaptive braking solution is providing to be insufficient or incapable of slowing the train, the adaptive braking solution can include all the rail cars in the braking solution.

### BRIEF DESCRIPTION OF THE DRAWINGS

FIG. 1 is a schematic illustration of an example train that includes a locomotive and six rail cars according to the principles of the present invention;

FIG. 2 is a schematic illustration of example elements, e.g., a processor or controller and memory, comprising the HEU of the locomotive and the ECP controller of each rail car shown in FIG. 1, and including an optional human machine interface (HMI) of the HEU and an optional transmitter for communicating with an optional RF transceiver of the HEU according to the principles of the present invention;

FIG. 3 is a schematic illustration of example sources or sensors that can be used individually or in combination and which can communicate data or information to the HEU according to the principles of the present invention;

FIG. 4 is an exploded view of a generic bogie according to the principles of the present invention; and

FIG. 5 is a flow diagram of an example method of braking in accordance with the principles of the present invention.

### DESCRIPTION OF THE INVENTION

For the purposes of the following detailed description, it is to be understood that the invention may assume various alternative variations and step sequences, except where expressly specified to the contrary. It is also to be understood that the specific devices and methods described in the following specification are simply exemplary embodiments, examples, or aspects of the invention. Moreover, other than in any operating examples, or where otherwise indicated, all numbers expressing, in preferred and non-limiting embodiments, examples, or aspects, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the Doctrine of Equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

It is also to be understood that the specific devices and processes illustrated in the attached drawings, and described in the following specification, are simply exemplary embodiments, examples, or aspects of the invention. Hence, specific dimensions and other physical characteristics related to the embodiments, examples, or aspects disclosed herein are not to be considered as limiting. Certain preferred and non-limiting embodiments, examples, or aspects of the present invention will be described with reference to the accompanying figures where like reference numbers correspond to like or functionally equivalent elements.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise.

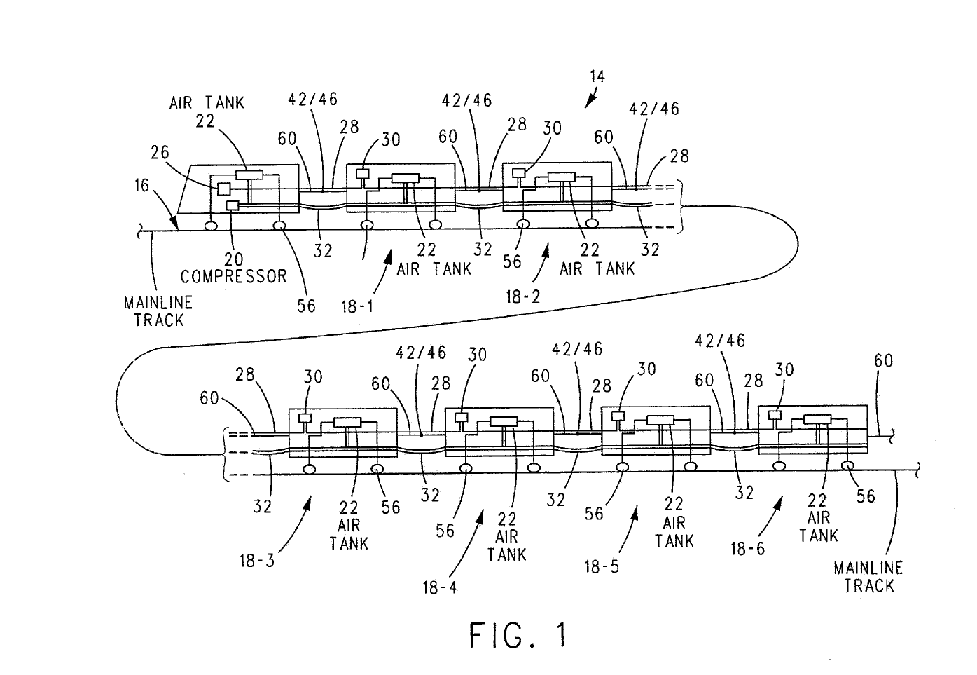

With reference to FIG. 1, a train 14 includes a locomotive 16 and a number of train or rail cars 18-1-18-X, where “X” can be any whole number ≥2. In examples discussed hereinafter, train 14 will be described as including six cars 18-1-18-6. However, this is not to be construed in a limiting sense.

Locomotive 16 includes a compressor 20 which operates in a manner known in the art to supply pressurized air to a brake pipe 32 which in turn supplies pressurized air to an air tank 22 in locomotive 16 and in each car 18 in a manner known in the art. The pressurized air stored in each air tank 22 is utilized to control the braking of locomotive 16 and each car 18 of train 14 in a manner known in the art and discussed hereinafter. Locomotive 16 includes an electronically controlled pneumatic (ECP) head-end-unit (HEU) 26. HEU 26 is coupled via an ECP trainline 28 to an ECP controller 30 in each car 18.

In an example, ECP trainline 28 acts in the nature of a communication network, such as, for example, without limitation, a local area network (LAN), between at least each ECP controller 30 and HEU 26. More specifically, in response to brake command signals provided by HEU 26 to each ECP controller 30 via trainline 28, each ECP controller 30 controls the pressure of pressurized air supplied from its air tank 22 to the pneumatic brakes of its car in accordance with the brake command signals, thereby controlling the percent braking of the car 18.

In a conventional ECP braking mode of operation, the brakes of the train are controlled in accordance with the Association of American Railroads (AAR)S-4200 standard braking profile known in the art. In accordance with the S-4200 standard, each ECP controller 30 can be responsive to a single train brake command output by HEU 26 on ECP trainline 28. For example, in response to HEU 26 outputting a train brake command of, for example, 20% braking on ECP trainline 28, each ECP controller 30 causes the brakes of its corresponding car 18 to be set to 20% of full braking. In another example, in response to HEU 26 outputting a 50% train brake command (50% braking), each ECP controller 30 causes the brakes of its corresponding car 18 to be set to 50% of full braking. In yet another example, in response to HEU 26 outputting a 100% train brake command (100% braking), each ECP controller 30 causes the brakes of its corresponding car 18 to be set to 100% braking, or full braking. For emergency braking, HEU 26 outputs a 120% train brake command.

As can be seen, each ECP controller 30 acts on train brake commands output by HEU 26 in the same manner, namely, the brakes of each car 18 are set to the same percentage of full braking. Hence, in accordance with the S-4200 standard, and except for pneumatic and mechanical variations between the pneumatic brakes of each car 18, in response to a train brake command output by HEU 26 the brakes of each car 18 respond in the same manner, i.e., the brakes of each car 18 are set to the same percentage of braking as the brakes of each other car 18.

Also, the brakes of locomotive 16 can be controlled in a similar manner by HEU 26. Namely, in response to outputting a 20%, 50%, or 100% train brake command to ECP trainline 28, HEU 26 also causes the brakes of locomotive 16 to assume the same percentage of braking as the cars 18 of train 14. Hence, by way of the S-4200 standard, the brakes of locomotive 16 and each car 18 of train 14 can be set to the same percentage of braking.

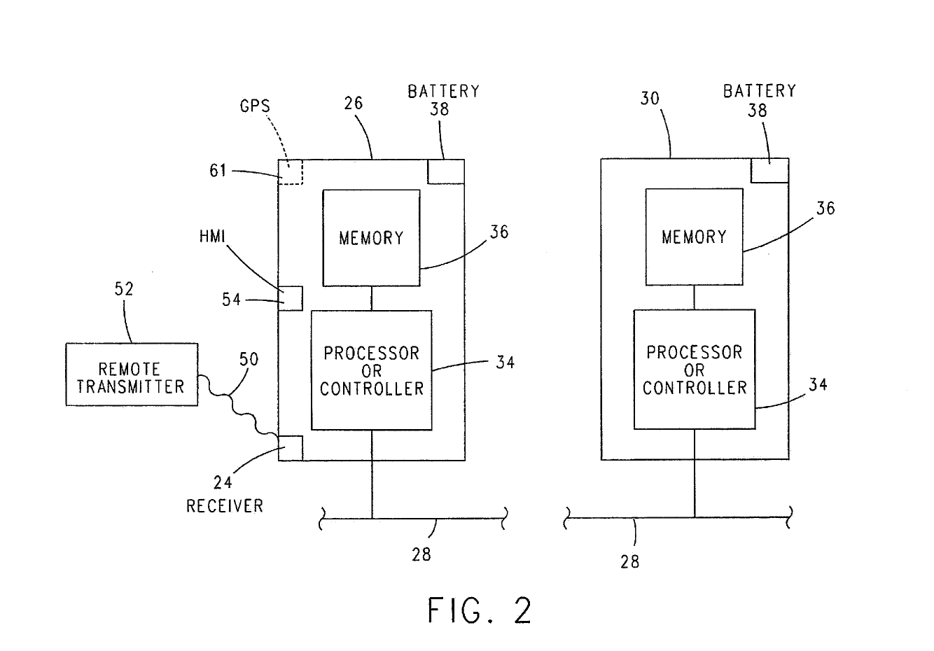

With reference to FIG. 2, in an example, HEU 26 and each ECP controller 30 includes a processor or controller 34 communicatively coupled to ECP trainline 28 and a memory 36 coupled to processor or controller 34 and operative for storing a software control program. For example, the memory 36 of HEU 26 can store a HEU software control program that, when executed by the processor or controller 34 of HEU 26, implements the S-4200 standard braking profile while the memory 36 of each ECP controller 30 stores an ECP software control program that, when executed by the processor or controller 34 of the ECP controller 30, implements the ECP controller 30 part of the S-4200 standard braking profile for controlling the braking of the corresponding car 18 in response to train brake commands received by the ECP controller 30 from HEU 26 operating under the control of the first HEU software control program. The HEU software control program stored in memory 36 of HEU 26 is configured to control the operation of the pneumatic brakes of each car 18 via the corresponding ECP controller 30 and to control the brakes of locomotive 16, all in a manner known in the art.

Each memory 36 can include dynamic, volatile memory, e.g., RAM, that loses program code and data stored therein when power to the memory 36 is lost or when overwritten by the corresponding processor or controller 34, and a non-volatile memory, e.g., ROM, flash memory, and the like, the latter of which (non-volatile memory) can store, at least, an embedded operating system for use by the corresponding HEU 26 or ECP controller 30 in the presence or absence of power applied to the non-volatile memory of the corresponding processor or controller 34.

In normal operation, each ECP controller 30 receives electrical power for its operation via ECP trainline 28. Each ECP controller 30 can also include a battery 38 that provides electrical power to the corresponding processor or controller 34 and memory 36 in the event power on ECP trainline 28 is lost, e.g., due to a separation of the part of the trainline 28 joining said ECP controller 30 to HEU 26.

HEU 26 receives electrical power for its operation from a battery or generator of locomotive 16. HEU 26 can also include a battery 38 that provides electrical power to processor or controller 34 and memory 36 of HEU 26 in the event no electrical power is being provided by the battery or generator of locomotive 16

During the formation of the train 14, information regarding the train, including the sequence of cars, locomotives, unique car and locomotive IDs (or data addresses), and other static information parameters regarding train 14 is acquired by HEU 26 and stored in memory 36 thereof. This consist information can include the identification of locomotive 16 and each car 18 of train 14 as well as their positions within train 14. For example, where train 14 includes a lead locomotive 16 and cars 18-1-18-6 as shown in FIG. 1, the consist information can include data identifying locomotive 16 as the first vehicle of the consist; car 18-1 as the second car of the consist that is positioned between locomotive 16 and car 18-2; that car 18-2 as the third car of the consist that is positioned between cars 18-1 and 18-3; and so forth including that car 18-6 is the final car of the consist.

In addition, because ECP trainline 28 acts in the nature of a communication network, such as, for example, without limitation, a local area network (LAN), each ECP controller 30 can have a unique data address that HEU 26 can use to selectively communicate with said ECP controller 30 independent of each other ECP controller 30. The unique data address of each ECP controller 30 can be preassigned to said ECP controller 30 or can be assigned during the formation of train 14. In this manner, HEU can selectively address and communicate with one ECP controller 30 independent of each other ECP controller 30.

Having thus described the S-4200 standard and the operation of HEU 26 and each ECP controller 30 to implement the S-4200 standard, a new method of braking in accordance with the principles described herein, which new method of braking is a departure from the S-4200 standard, will now be described with reference to FIGS. 1 and 2.

In a preferred and non-limiting embodiment, example, or aspect, benefits of this new method of braking can include: optimizing deceleration or stopping of the train; optimizing wear on the brake pads of the brakes of each car 18; distributing wear on the brake pads from cars 18 with less brake pad life to cars with more; and the like.

In a preferred and non-limiting embodiment, example, or aspect, the new method of braking generally includes a subset (all or less than all) of cars 18 of train 14 participating in braking and, optionally, the percent braking of each participating car. In a preferred and non-limiting embodiment, example, or aspect, the method of braking can occur in about real-time. However, this is not to be construed in a limiting sense.

In a preferred and non-limiting embodiment, example, or aspect, with train 14 travelling or moving, for example, on a mainline track, in response to a brake command issued by an operator of train 14, located for example, in locomotive 16, in a manner known in the art or herein after developed, HEU 26 can issue a unique braking command, or no braking command, to each ECP controller 30 of a subset of the cars 18 of train 14. In a preferred and non-limiting embodiment, example, or aspect, the train operator can issue the braking command to HEU 26 via HMI 54 that is part of our coupled to HEU 26. Herein the unique braking command issued to each ECP controller 30 means that each ECP controller 30 receives a command to set the brakes of its car 18 to a percentage of braking, between 0% and maximum braking, independent of the setting of the brakes of each other car 18.

In a preferred and non-limiting embodiment, example, or aspect, starting from a condition where the brakes of each car 18 are set to 0% braking when train 14 is travelling or moving on a mainline track, HEU 26 can, via ECP trainline 28, issue unique braking commands to the ECP controllers 30 of each car 18-1 through 18-6 respectively that cause the brakes of each car 18 to be set, in a preferred and non-limiting embodiment, example, or aspect, as follows: (1) car 18-1—20% braking; (2) car 18-2—25% braking; (3) car 18-3—30% braking; (4) car 18-4—35% braking; (5) car 18-5—40% braking; and (6) car 18-6—45% braking.

In a preferred and non-limiting embodiment, example, or aspect, starting from a condition where the brakes of each car 18 are set to 0% braking when train 14 is travelling or moving on a mainline track, HEU 26 can, via ECP trainline 28, issue unique braking commands to the ECP controller 30 of each car 18-1 through 18-6 respectively that cause the brakes of each car 18 to be set, in a preferred and non-limiting embodiment, example, or aspect, as follows: (1) car 18-1—20% braking; (2) car 18-2—30% braking; (3) car 18-3—40% braking; (4) car 18-4—30% braking; (5) car 18-5—20% braking; and (6) car 18-6—10% braking.

In a preferred and non-limiting embodiment, example, or aspect, starting from a condition where the brakes of each car 18 are set to 0% braking when train 14 is travelling or moving on a mainline track, HEU 26 can, via ECP trainline 28, issue unique braking commands to the ECP controller 30 of cars 18-1, 18-3, 18-5, and 18-6 respectively that cause the brakes of these cars to be set, in a preferred and non-limiting embodiment, example, or aspect, as follows: (1) car 18-1—20% braking; (2) car 18-3—25% braking; (3) car 18-5—30% braking; and (4) car 18-6—35% braking. In this example, braking commands were not issued to the ECP controllers 30 of cars 18-2 and 18-4, whereupon the brakes of these cars remain at 0% braking.

In a preferred and non-limiting embodiment, example, or aspect, starting from a condition where the brakes of each car 18 are set to 0% braking when train 14 is travelling or moving on a mainline track, HEU 26 can, via ECP trainline 28, issue unique braking commands to the ECP controller 30 of cars 18-1, 18-2, 18-4, and 18-6 respectively that cause the brakes of these cars to be set, in a preferred and non-limiting embodiment, example, or aspect, as follows: (1) car 18-1—20% braking; (2) car 18-2—25% braking; (3) car 18-4—20% braking; and (4) car 18-6—10% braking. In this example, braking commands were not issued to the ECP controllers 30 of cars 18-3 and 18-5, whereupon the brakes of these cars remain at 0% braking.

In a preferred and non-limiting embodiment, example, or aspect, when train 14 is travelling or moving on a mainline track and starting from a condition where the brakes of the cars 18 are set as follows: (1) car 18-1—20% braking; (2) car 18-2—0% braking; (3) car 18-3—25% braking; (4) car 18-4—0% braking; (5) car 18-5—30% braking; and (6) car 18-6—35% braking, HEU 26 can, via ECP trainline 28, issue unique braking commands to the ECP controller 30 of cars 18-1-18-6 respectively that cause the brakes of these cars to be set, in a preferred and non-limiting embodiment, example, or aspect, as follows: (1) car 18-1—20% braking; (2) car 18-2—30% braking; (3) car 18-3—0% braking; (4) car 18-4—30% braking; (5) car 18-5—0% braking; and (4) car 18-6—10% braking. In this example, the braking commands issued by HEU 26 to the ECP controller 30 of cars 18-1-18-6 changed the composition of cars 18 participating in braking, namely, cars 18-3 and 18-5 were dropped and cars 18-2 and 18-4 were added. In this preferred and non-limiting embodiment, example, or aspect, viewed differently, the braking commands issued by HEU 26 to the ECP controller 30 of certain cars changed the percent braking of some of the cars while maintaining the same percent braking of other cars. Namely, car 18-1 maintained at 20% braking; car 18-2 changed from 0% braking to 30% braking; car 18-3 changed from 25% braking to 0% braking; car 18-4 changed from 0% braking to 10% braking; car 18-5 changed from 30% braking to 0% braking; and car 18-6, changed from 35% braking to 10% braking.

The various percent brakings described in the above preferred and non-limiting embodiments, examples, or aspects, are for the purpose of illustration only and are not to be construed in a limiting sense since it is envisioned that HEU 26 can selectively set the percent braking on each car 18 in to any suitable and/or desirable percent level independently of the percent level braking of each other car 18 of train 14.

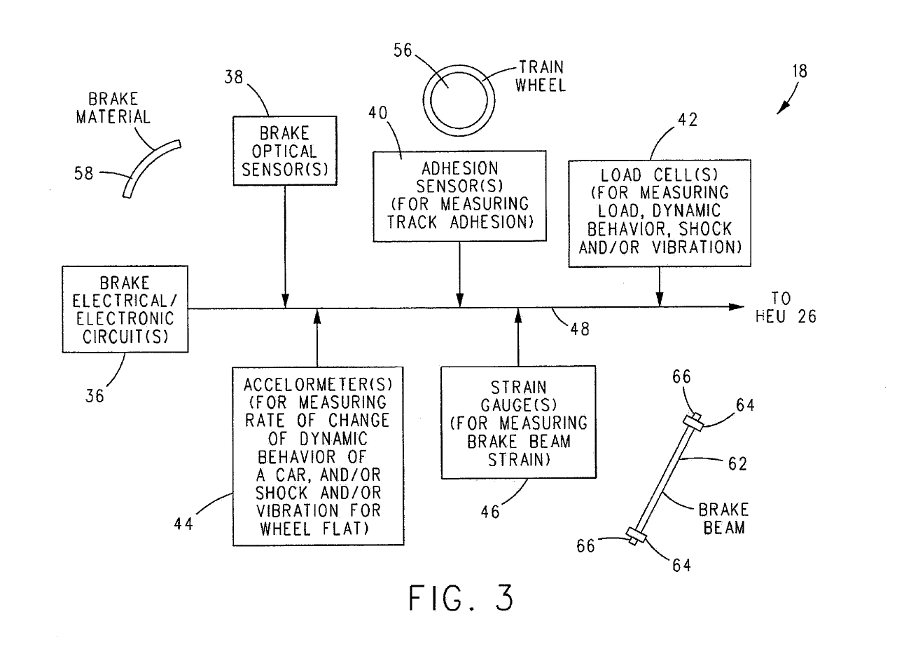

With reference to FIG. 3 and with continuing reference to FIGS. 1 and 2, in a preferred and non-limiting embodiment, example, or aspect, HEU 26 can selectively set the percent braking on each car 18 independently of the percent braking of each other car 18 of train 14 based on input from one or more sources or sensors which can communicate data or information to HEU 26, directly or indirectly, in any suitable and/or desirable manner. In a preferred and non-limiting embodiment, example, or aspect, these one or more sources or sensors can include one or more or all of the following:

one or more electrical/electronic circuits 36, on each of one or more of the cars 18, that is designed to conduct or block a signal based on an amount of wear of the material of a brake shoe/pad;

one or more optical sensors 38, e.g., one or more cameras, on each of one or more of the cars 18, each optical sensor positioned to observe an amount of material remaining on brake pad or brake shoe;

a remote transmitter 52 which can transmit weather/environmental conditions to a receiver coupled to or part of HEU 26 via a wired and/or wireless communication link 50 (see FIG. 2);

one or more adhesion sensors 40, on each of one or more of the cars 18, for measuring track adhesion, wheel slip, and/or wheel skid;

one or more load cells 42, on each of one or more of the cars 18, for measuring a load carried by the car and/or for measuring dynamic behavior of the car;

one or more accelerometers 44, on each of one or more of the cars 18, for measuring a rate of change in the dynamic behavior of the car;

one or more stain gauges 46, on each of one or more of the cars 18, for measuring strain on a brake beam; and

one or more accelerometers 44, on each of one or more of the cars 18, for measuring a shock and vibration of the car, e.g., to indicate a wheel flat.

In a preferred and non-limiting embodiment, example, or aspect, each of the one or more sources 38-46 can communicate data or information to HEU 26 via a communication link 48, which can be separate from or a part of ECP trainline 28. In a preferred and non-limiting embodiment, example, or aspect, communication link 48 can represent and include processing circuitry, not specifically shown, for processing, as necessary, the output(s) of each of the one or more sources 38-46 as needed for use by HEU 26. In a preferred and non-limiting embodiment, example, or aspect, processing circuitry can include one or more analog-to-digital (A/D) converters for converting analog outputs of sources 38-46 into a digital form for processing by HEU 26. In a preferred and non-limiting embodiment, example, or aspect, although communication link 48 is represented a single line in FIG. 3, this is not to be construed in a limiting sense since communication link 48 can be any number of lines that can be used to communicate data and/or information from sources 38-46 to HEU 26. Moreover, in a preferred and non-limiting embodiment, example, or aspect, communication link 48 can be in the nature of, for example, without limitation, a wired and/or wireless network, including a local area network (LAN) which can communicate data and/or information from one or more of sources 38-46 to HEU 26. In a preferred and non-limiting embodiment, example, or aspect, the use of any configuration of wired and/or wireless communication link 48 that enables HEU 26 to receive data and/or information from communication link 48 is envisioned, including, for example, the IoT.

Brake Wear:

In a preferred and non-limiting embodiment, example, or aspect, HEU 26 can process the output of the each of one or more optical sensors 38 on one or more cars 18 to determine the amount of material remaining on a brake shoe/pad. Based on this determination, HEU 26 can favor braking by cars having more material remaining on its brake shoes or brake pads over cars having brake shoes or brake pads with less material.

In a preferred and non-limiting embodiment, example, or aspect, assume cars 18-1, 18-3, and 18-5 are optically determined to each have greater than 75% braking material on the brakes thereof and cars 18-2, 18-4, and 18-6 are optically determined to have greater than 50% braking material on the brakes thereof. In this scenario, for a desired braking requirement for the entire train 14, HEU 26 can set the brakes of cars 18-1, 18-3, and 18-5 at a greater percentage of braking than the brakes of cars 18-2, 18-4, and 18-6. Moreover, in this preferred and non-limiting embodiment, example, or aspect, the brakes of each car 18-1, 18-3, and 18-5 can be set to the same and/or different percentage of braking as each other car and the brakes of each car 18-2, 18-4, and 18-6 can be set to the same and/or different percentage of braking as each other car. In other words, each car 18 can be set to a different percentage of braking based on the amount of brake material remaining on one or more brake shoes or brake pads of the car 18.

In a preferred and non-limiting embodiment, example, or aspect, the useable material of a brake shoe/pad can have two or more colors that can be optically detected to determine the material remaining. In a preferred and non-limiting embodiment, example, or aspect, one color may indicate to HEU 26 useable brake material while a second, different color can indicate that the brake shoe/pad requires replacement. In a preferred and non-limiting embodiment, example, or aspect, additional colors can indicate to HEU 26 different levels of brake material, e.g., between greater than 75%, greater than 50%, greater than 25%, and a percentage indicting that the brake shoe/pad requires replacement.

In a preferred and non-limiting embodiment, example, or aspect, electrical/electronic circuit 36 can be provided for detecting when there is useable brake material and when the brake material is worn sufficiently such that replacement of the brake material or the brake shoe/pad is required. In a preferred and non-limiting embodiment, example, or aspect, the electrical/electronic circuit can detect the presence or absence of a signal when the brake material is worn sufficiently such that replacement of the brake material or the brake shoe/pad is required. Conversely, the electrical/electronic circuit can detect the other of the presence or absence of a signal when the brake material useable and not worn such that replacement of the brake material or the brake shoe/pad is required. In a preferred and non-limiting embodiment, example, or aspect, the electrical/electronic circuit can also detect one or more additional levels of an amount of useable brake material. Electrical/electronic circuits for electronic brake wear sensing are known in the art and are commercially available.

In a preferred and non-limiting embodiment, example, or aspect, HEU 26 can be provided with the output of the electrical/electronic circuit detecting the useable brake material or amount of useable brake material on each car 18 and/or on each brake of each car 18 and can favor braking by cars having more material remaining on its brake shoes or brake pads over cars having brake shoes or brake pads with less material.

In a preferred and non-limiting embodiment, example, or aspect, assume that the electrical/electronic circuit determines that the brakes of cars 18-1, and 18-2 have greater than 75% braking material, the brakes of cars 18-3 and 18-4 have about 40% braking material, and the brakes of cars 18-5, and 18-6 require replacement of the braking material. In this scenario, for a desired braking requirement for the entire train 14, HEU 26 can set the brakes of cars 18-1 and 18-2 to a first percentage of braking e.g., 50% braking, set the brakes of cars 18-3 and 18-4 to a second percentage of braking, e.g., 30% braking, less than the first percentage of braking, and set the brakes of cars 18-5 and 18-6 to a third percentage of braking, e.g., 0% braking, less than the second percentage of braking. In a preferred and non-limiting embodiment, example, or aspect, moreover, in this preferred and non-limiting embodiment, example, or aspect, the brakes of one or more of the pair of cars (18-1, 18-2); (18-3, 18-4); and (18-5, 18-6) can be set to different percentages of braking. In this manner, HEU 26 is able to dynamically adapt the braking of train 14 in response to the dynamically changing amount of braking material on each car 18 and/or on each brake of each car 18.

Weather/Environmental Conditions:

In a preferred and non-limiting embodiment, example, or aspect, HEU 26 can be provided with weather/environmental conditions. In a preferred and non-limiting embodiment, example, or aspect, the weather/environmental conditions can be provided to HEU 26 in any suitable and/or desirable manner, e.g., manually input via human-machine interface (HMI) 54, automatically input via receiver 24 receiving the data/information regarding the weather/environmental conditions from remote transmitter 52 via communication link 50, or the combination thereof.

In a preferred and non-limiting embodiment, example, or aspect, the weather/environmental conditions can be input into HEU 26 at any suitable and/or desirable time, e.g., before train 14 departs location A, while train 14 travels on a mainline track through an area, or the combination thereof. In a preferred and non-limiting embodiment, example, or aspect, the weather/environmental conditions can include local weather events and notifications from local, regional, or national sources; information about climate conditions, such as, without limitation, temperature, wind velocity and direction; moisture amounts and types, e.g., snow, rain, sleet, etc.; navigation and terrain information; and the like. In a preferred and non-limiting embodiment, example, or aspect, train 14 can include suitable means to measure weather/environmental conditions can temperature, wind velocity and direction; moisture amounts, and the like, and to input the measured weather/environmental conditions into HEU 26. In a preferred and non-limiting embodiment, example, or aspect, the weather/environmental conditions input into HEU 26 can include local weather/environmental conditions at the present location of train or any future location of train 14.

In a preferred and non-limiting embodiment, example, or aspect, HEU 26 can use the input weather/environmental conditions to control which cars 18 are used for braking and the percentage of braking by each car used for a desired braking requirement for the entire train 14. In a preferred and non-limiting embodiment, example, or aspect, in response to snowy conditions input into HEU 26 for the present location of train 14, HEU 26 can set car 18-6 to the highest level or percentage of braking, car 18-5 to a percentage of braking between cars 18-4 and 18-6, car 18-4 to a percentage of braking between cars 18-3 and 18-5, and so forth with car 18-1 set at the lowest percentage of braking. In a preferred and non-limiting embodiment, example, or aspect, the percent braking by car 18-1-18-6 can be reversed from the prior example with car 18-1 providing the highest percentage of braking, car 18-6 the lowest highest percentage of braking, and cars 18-2-18-5 providing progressively decreasing percentages of braking.

In a preferred and non-limiting embodiment, example, or aspect, the percentage of braking provided by each car 18 can be mixed in any suitable and/or desirable manner to achieve a desired braking requirement for the entire train 14 based on the weather/environmental conditions input into HEU 26. In a preferred and non-limiting embodiment, example, or aspect, cars 18-5 and 18-6 can be set to same percentage of braking; cars 18-1 and 18-2 can be set to same percentage of braking less than cars 18-5 and 18-6, and cars 18-3 and 18-4 can be set to 0% braking. Of course, any other suitable and/or desirable combinations of percentages braking by the cars 18 of train 14 to achieve a desired braking requirement for the entire train 14 are envisioned, including each car have a different percentage of braking between 0% braking and maximum braking. In this manner, HEU 26 is able to dynamically adapt the braking of train 14 in response to changing snow and moisture conditions on the track.

Track Adhesion:

In a preferred and non-limiting embodiment, example, or aspect, HEU 26 can use the output of one or more adhesion sensors 40 as an indication of track adhesion. Ideally, adhesion between each wheel 56 and the track is wanted during acceleration or braking and not wanted when coasting. During braking, low adhesion can extend the braking distance, e.g., increase the distance to reach a particular lower speed or a full stop in a manner that avoids slippage between the wheel 56 and the mainline track. Too less or too much adhesion can adversely affect the train's 14 journey. Moreover, an ideal amount or range of adhesion may not be a fixed value. It can change with changing environmental conditions, geographical location, behavior of the rail cars during braking, the type and nature of cargo being hauled, etc.

While travelling or moving on a mainline track, low adhesion can reduce train's 14 acceleration and disrupt the travel schedule of the affected train and other trains in the network. In a preferred and non-limiting embodiment, example, or aspect, adhesion should be low to reduce energy consumption. If adhesion is too high, wheels and rails can be subject to excessive shear stress, leading to additional wear and possibility surface fatigue.

As the wheel-rail contact is an open system, adhesion between the wheel and rail can be affected by contaminants. Contaminants, which can be any foreign substance, applied both intentionally and unintentionally, at the wheel-rail interface, can make wheel-rail adhesion either too high or too low and difficult to predict. The prediction of wheel-rail adhesion can be important not only to railway operation but also to the simulation of multi-body vehicle dynamics.

In a preferred and non-limiting embodiment, example, or aspect, track adhesion and, more particularly, wheel slip or wheel skid, can be determined by an adhesion sensor based on a difference between a linear speed of a wheel 56 of at least one rail car 18 and a speed (velocity or true ground speed) of train 14 determined in any suitable and/or desirable manner. In a preferred and non-limiting embodiment, example, or aspect, adhesion sensor 40 can be realized by, for example, a magnetic sensor which is one means known in the art for the sensing position, distance and speed of a rotating object, such as a train wheel 56. Based on the sensed speed of rotation of a wheel 56 by adhesion sensor 40, a linear speed of the wheel 56 can be determined in a manner known in the art, e.g., ωr: where ω (radians/sec), and r is the wheel radius. Based on any difference between the thus determined linear speed of the wheel 56 and the overall speed of the train determined or sampled at or about the same time, a value of track adhesion, wheel slip, or wheel skid can be determined by HEU 26, e.g., calculated or from empirical data. In a preferred and non-limiting embodiment, example, or aspect, data regarding track adhesion, wheel slip, or wheel skid for a wheel 56 can be determined by HEU 26 or by a separate processor (not shown) processing the output of the wheel's 56 adhesion sensor 40. In a preferred and non-limiting embodiment, example, or aspect, the speed of train 14 can be determined via speed sensor coupled to a reference wheel 56 of train 14, via a GPS 61 (or other navigation equipment or system) coupled to HEU 26, via Doppler radar, or any other means. See e.g., Wolfs et al., “Wheel Speed, Wheel Slip and True Ground Speed Detection Options for Brake Vans”, Centre for Railway Engineering, CRE-R 131 ELEC-2/05, Sep. 21, 2005, which is incorporated herein by reference.

In a preferred and non-limiting embodiment, example, or aspect, the percentage of braking provided by each car 18 can be mixed in any suitable and/or desirable manner to achieve a desired braking requirement for the entire train 14 based on track adhesion, wheel slip, and/or wheel skid conditions of one or more wheels 56 of train 14 sensed by one or more adhesion sensors. In a preferred and non-limiting embodiment, example, or aspect, data regarding track adhesion, wheel slip, or wheel skid can be processed by HEU 26 to determine the percentage braking to be provided by each car 18 to achieve a desired braking requirement for the entire train 14. In a preferred and non-limiting embodiment, example, or aspect, if one or both of cars 18-3 and 18-4 are experiencing low track adhesion, wheel slip, or wheel skid conditions, HEU 26 can set the brakes of one or both of cars 18-3 and 18-4 to 0% braking, to a low value of braking, e.g., 5% braking or the combination, e.g., 0% and 5% braking, respectively, and can set the brakes of each other car 18-1, 18-2, 18-5, and 18-6 to a different percentage of braking, e.g., 10%, 20%, 30% and 40% braking, respectively; set the brakes of each car 18-1, 18-2, 18-5, and 18-6 to the same percentage of braking e.g., 25%, or set the brakes of each car 18-1, 18-2, 18-5, and 18-6 to a mixture of the same and different percentages of braking, e.g., 10%, 10%, 30% and 40% braking, respectively. Of course, the use of other suitable and/or desirable combinations of percentage braking by each car 18 when one or more wheels 56 are experiencing low track adhesion, wheel slip, and/or wheel skid conditions to achieve a desired braking requirement for the entire train 14 are envisioned. In this manner, HEU 26 is able to dynamically adapt the braking of train 14 in response to changing track adhesion, wheel slip, and/or wheel skid conditions on the track.

Car Loading:

Physical load measurements of a loaded car 18 may be done physically at a loading dock. Since the type and quantity of cargo onboard each car may be known in advance, it may be one of the easier things to determine and input into HEU 26, either manually, via HMI 54, or via communication link 50. In a preferred and non-limiting embodiment, example, or aspect, each of one or more cars 18 can have one or more embedded load cells 42 for electronically determining car 18 load which can be communicated to HEU 26 via communication link 48. In a preferred and non-limiting embodiment, example, or aspect, the physical or electronic load calculation can be optionally used with machine vision as an aid to determining if the car 18 is empty, partially full, completely full, or overloaded. More than just the car load, in a preferred and non-limiting embodiment, example, or aspect, it can be desirable for HEU 26 to develop dynamic behavior of the cargo loaded onboard each of one or more cars 18 at various speeds, terrain, inclines, declines, weather/environmental conditions, when subjected to braking forces. How a car 18 loaded with solid cargo will react will be different from how a car 18 loaded with a liquid cargo will react.

Rail car loads often range from about 60,000 lbs. (27,215 Kg) empty to about 265,000 lbs. (120,200 Kg) fully laden. In a preferred and non-limiting embodiment, example, or aspect, the load on each car 18 can be measured mechanically or optically (e.g., a camera) using the amount of compression of the springs in the trucks (bogies). For large unit trains, such as trains carrying coal or ore (using open top rail cars), the tendency is to load to full load at best, and an overload at worst. The braking systems for cars 18 are designed to operate at around the peak load with a +/−a safety limit. The behavior of rail cars 18 that are overladen, particularly when travelling at higher speeds and on an incline or decline, can be unpredictable.

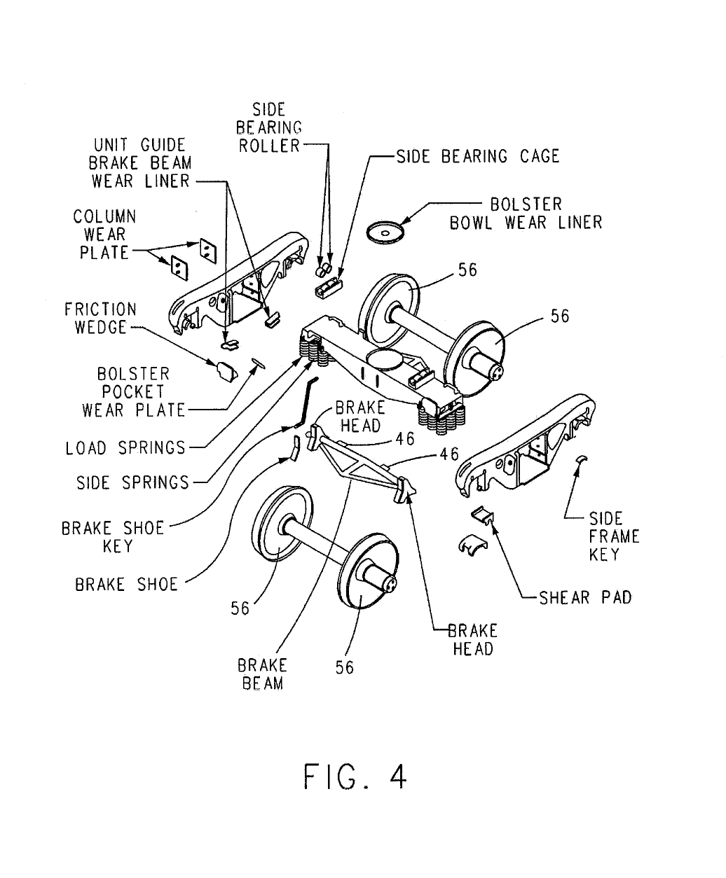

In a preferred and non-limiting embodiment, example, or aspect, the roll behavior of a rail car 18 can be monitored via the output(s) of one or more load cells 42 mounted, for example, without limitation, on one or more side roller bearing/side bearing cage arrangements of a bogie. An exploded view of a generic bogie is shown in FIG. 4. Side roller bearing/side bearing cage arrangements are known in the art and will not be further described herein. In a preferred and non-limiting embodiment, example, or aspect, the percent loading on a rail car 18 can be monitored by HEU 26 via the one or more load cells 42, or optically, via one or more optical sensors 38, determining the percent compression of one or more springs of the car 18 between a typically minimum and a typical max and an overload threshold. In a preferred and non-limiting embodiment, example, or aspect, by monitoring the output of the load cells 42, percent compression, or any changes thereof, between trucks (bogies) at the front and the back of a car 18, HEU 26 can determine pitch conditions of the car 18. In a preferred and non-limiting embodiment, example, or aspect, by monitoring the output of the load cells 42, percent compression, or any changes thereof between the right and left side of a truck (bogie) of a car 18, HEU 26 can determine roll conditions of the car 18. The changing force measured by each load cell 42 can be a direct or indirect measure of the G forces on the car 18.

In a preferred and non-limiting embodiment, example, or aspect, in response to HEU 26 determining based on the output of the load cells 42 in one or more cars 18, that said car(s) 18 are experiencing undesirable levels of pitch and/or roll, e.g., without limitation, when train 14 is travelling on a curve, an incline, or a decline, HEU 26 can implement a desired braking requirement for the entire train 14 to reduce or eliminate the undesirable levels of pitch and/or roll by setting the brakes of each car 18 to a different percentage of braking or to a mixture of the same and different percentages of braking. In a preferred and non-limiting embodiment, example, or aspect, if HEU 26 determines that car 18-3 is experiencing undesirable levels of pitch and/or roll, HEU 26 can set the brakes of car 18-3 to 0% or 5% braking to avoid potentially exacerbating the undesirable levels of pitch and/or roll of car 18-3, and can set the brakes of cars 18-1, 18-2, 18-4, 18-5, and 18-6 to 10%, 20%, 30%, 40%, and 50% braking in an attempt to reduce or eliminate the undesirable levels of pitch and/or roll of car 18-3. In a preferred and non-limiting embodiment, example, or aspect, HEU 26 can set the brakes of car 18-3 to 0% or 5% braking and can set the brakes of each car 18-1, 18-2, 18-4, 18-5, and 18-6 to the same percentage of braking e.g., 25%, or can set the brakes of each car 18-1, 18-2, 18-4, 18-5, and 18-6 to a mixture of the same and different percentages of braking, e.g., 10%, 10%, 30%, 40%, and 50% braking, respectively. Of course, the use of other suitable and/or desirable combinations of percentage braking by each car 18 when one or more cars are experiencing undesirable levels of pitch and/or roll to achieve a desired braking requirement for the entire train 14 that reduces or eliminates the undesirable levels of pitch and/or roll are envisioned. In this manner, HEU 26 is able to dynamically adapt the braking of train 14 in response to changing pitch and/or roll conditions of one or more cars 18.

Coupler Load:

Locomotive 16 is joined to car 18-1 by a pair of couplers 60 and each pair of cars 18 are joined together by a pair of couplers 60. A load cell 46 and/or a strain gauge 46 can be coupled to each of one or more of couplers 60 of train 14 to measure in-train forces. In a preferred and non-limiting embodiment, example, or aspect, HEU 26 can, based on the output(s) of these load cell(s) 46 and/or a strain gauge(s) 46, implement a desired braking requirement for the entire train 14 to reduce an undesirable level of in-train force experienced by one or more of the couplers 60. In a preferred and non-limiting embodiment, example, or aspect, assume that during a braking event that HEU 26 determines from the output(s) of a load cell 46 and/or strain gauge 26 mounted to one of the couplers 60 between cars 18-1 and 18-2, that the in-train forces on said coupler 60 is above a desired level. In this scenario, HEU 26 can dynamically adjust the percentage of braking by each car 18 in a manner that reduces the in-train forces on said coupler. For example, to reduce the in-train forces on the coupler 60, HEU 26 can reduce the percent braking of car 18-1 and can increasing the percent braking of one or more of cars 18-2-18-6, or vice versa depending on whether the undesirable levels of in-train forces are compression or strain. In this manner, HEU 26 is able to dynamically adapt the braking of train 14 in response to changing level of in-train force experienced by one or more of couplers 60.

Wheel Flat:

When the braking system of a car provides more braking that necessary, one or more wheels 56 of one or more cars 18 can lock up, possibly resulting in a wheel flat condition for each affected wheel 56. A wheel flat condition is when the wheel 56 abrades against the steel rail as the wheel locks up (and doesn't rotate) during braking. This can result in a wheel flat, i.e., a flat surface on the circular surface of the wheel. Apart from a wheel flat, the locking of the wheel can also result in increased local temperature around the wheel flat.

As 14 train continues on its journey, each wheel flat, which will repeat its contact with the steel rail every rotation, can increase the amount of shock and vibration experienced by the car 18. Such effect can be measured on the truck (bogie) and also on the car 18 and perhaps even on the cargo carried onboard the car 18. The intensity of the shock and vibration can directly correspond to the intensity of the wheel flat or the amount of flatness of the steel wheel. A measure of the shock and/or vibration and a sudden spike in measurement can indicate a wheel flat.

In a preferred and non-limiting embodiment, example, or aspect, one or more load cells 42, one or more accelerometers 44, or some combination thereof mounted to a car 18, e.g., the bogie of a car 18, can be used to measure shock and/or vibration of the car 18, which shock and/or vibration can be indicative of a wheel flat condition. In a preferred and non-limiting embodiment, example, or aspect, assume that HEU 26 determines from the one or more load cells 42 and/or the one or more accelerometers 44 that a shock and/or vibration condition exists that indicates or suggests one or more wheels 56 of the car 18 has a wheel flat condition. In this scenario, when it is desired to brake train 14, HEU 26 can implement a desired braking requirement for the entire train 14 that reduces or eliminates the braking provided by said car 18. In a preferred and non-limiting embodiment, example, or aspect, if HEU 26 determines that car 18-5 has a wheel flat condition, based on detecting undesirable shock and/or vibration, HEU 26 can set the brakes of car 18-5 to a lower percent braking than the brakes of the other cars 18 of train 14 to avoid potentially exacerbating the wheel flat condition.

In a preferred and non-limiting embodiment, example, or aspect, upon determining that car 18-5 may have a wheel flat, HEU 26 can set the brakes of car 18-5 to 0% or 5% braking and can set the brakes of cars 18-1, 18-2, 18-4, 18-4, and 18-6 to 10%, 20%, 30%, 40%, and 50% braking. In a preferred and non-limiting embodiment, example, or aspect, upon determining that car 18-3 may have a wheel flat, HEU 26 can set the brakes of car 18-3 to 0% or 5% braking and can set the brakes of each car 18-1, 18-2, 18-4, 18-5, and 18-6 to the same percentage of braking e.g., 25%. In a preferred and non-limiting embodiment, example, or aspect, upon determining that car 18-5 may have a wheel flat, HEU 26 can set the brakes of each car 18-1, 18-2, 18-4, 18-5, and 18-6 to a mixture of the same and different percentages of braking, e.g., 10%, 10%, 30%, 40%, and 50% braking, respectively. Of course, the use of other suitable and/or desirable combinations of percentage braking by each car 18, when one or more cars are potentially experiencing wheel flat conditions, to achieve a desired braking requirement for the entire train 14 that reduces or avoids potentially exacerbating the wheel flat condition are envisioned. In this manner, HEU 26 is able to dynamically adapt the braking of train 14 in response to a wheel flat condition of one or more cars 18.

Brake Strain:

In a typical rail car 18 two brake heads 64, each holding a brake shoe 66, are attached to opposite ends of a brake beam 62 (see FIG. 4). As the brake shoes 66 push against the wheels 56, there is resultant strain in the brake beam 62. In a preferred and non-limiting embodiment, example, or aspect, each of one or more brake beams 62 on one or more cars 18 can be fitted with a strain-gauge 46. The degree and orientation of the strain detected by the strain-gauge 46 can provide an indication of the braking force being applied to the wheels 56.

In a preferred and non-limiting embodiment, example, or aspect, one or more strain-gauges 46 can be mounted to one or more brake beams 62 of one or more cars 18. Each strain-gauge 46 can be used to measure the strain on its brake beam in response to a braking force being applied to the wheels 56 by the brake shoes 66 via the brake heads 64 and can output a signal corresponding to the measured stain. In a preferred and non-limiting embodiment, example, or aspect, a strain-gauge 46 mounted to a brake beam of a fully laden (or overladen) car 18 is expected to measure more strain for a given percentage of braking than when said car 18 is empty. When the car 18 is between fully laden (or overladen) and empty, the stain-gauge 46 is expected, for a given percentage of braking, to measure a level of stain between that measured when the car is fully laden (or overladen) and empty.

In a preferred and non-limiting embodiment, example, or aspect, HUE 26 can set the percentage braking by each car 18 based on the output(s) of one or more strain-gauges 46 mounted on the brake beams of one or more cars 18. In a preferred and non-limiting embodiment, example, or aspect, assume cars 18-1 and 18-2, are fully laden with cargo, cars 18-3 and 18-4 are one-half laden with cargo, and cars 18-5 and 18-6 are empty (no cargo). In this scenario, if the brakes of each car 18 were set to the same percentage of braking, e.g., 40% braking, the outputs of the strain-gauges 46 of cars 18-1 and 18-2 would be expected to indicate higher levels of stain that the outputs of the strain-gauges 46 of cars 18-3 and 18-4, which would be expected to indicate higher levels of stain that the outputs of the strain-gauges 46 of cars 18-5 and 18-6. In a preferred and non-limiting embodiment, example, or aspect, for a desired braking requirement for the entire train 14, HEU 26 can set the percentage of braking of each car 18 such that the outputs of the strain-gauges 46 are at about the same level ±some predetermined tolerance, e.g., ±5%, 10%, or 15%. In a preferred and non-limiting embodiment, example, or aspect, HEU 26 can set brakes of cars 18-1 and 18-2 to 20% braking, set the brakes of cars 18-3 and 18-4 to 30% braking, and set the brakes of cars 18-5 and 18-6 to 40% to realize the outputs of the strain-gauges 46 being at about the same level ±some tolerance. In this manner, the brake beam of each car can experience about the same level of strain, ±some tolerance related to the ±tolerance of the outputs of the strain-gauges 46, regardless of cargo load carried by the car. In this manner, HEU 26 is able to dynamically adapt the braking of train 14 in response to stain on the brake beams of one or more cars 18.

Energy Harvesting:

Electrical power can be provided to any one or more of the foregoing sources or sensors via a generator of locomotive 16, one or more batteries 38, or, in a preferred and non-limiting embodiment, example, or aspect, via one or more energy harvesters mounted to one or more cars 18 or locomotive 16. Energy harvesters are known in the art as means for converting vibration, the flow of air (wind) or liquid, rotation of a moving part, e.g., a wheel 56 or axle of a car 18, into electrical energy. Information regarding energy harvesting from vibration normally associated with rail cars can be found at http://www.energyharvestingjournal.com/articles/1274/perpetuum-a-vibration-harvesting-company.

In a preferred and non-limiting embodiment, example, or aspect, it is envisioned that any one, or more, or all of the foregoing sources or sensors can be powered by one or more energy harvesters mounted to one or more cars 18 or locomotive 16.

Having thus described sources or sensors, the outputs of which can be used by HEU 26 to set the percentage of braking of each car 18 independently of each other cars to achieve a desired braking requirement for the entire train 14, an example of the use of one or more of said sources or sensors will now described.

In a preferred and non-limiting embodiment, example, or aspect, assume train 14 is travelling on a track from location A to location B. Before leaving location A, the train operator will have accurate information regarding the following: where is the train headed; how many rail cars; cargo and weight of cargo on each of the rail cars; duration of travel to location B; existing conditions (traffic related, weather related, work related); and existing health condition of the rail cars (things like brake shoe health, brake system health, rail car health, coupler health), In a preferred and non-limiting embodiment, example, or aspect, existing health condition of the rail cars can be determined via data enablement (IoT). However, this is not to be construed in a limiting sense.

Before the present invention, the amount of braking applied on the train from the locomotive is based on the train operator's (driver/Engineer-in-Charge) discretion. No two train operators have the same belief in terms of how much braking to apply, when, etc. It's more an art than a science.

In a preferred and non-limiting embodiment, example, or aspect, the train operator can indicate to the ‘adaptive braking system’, via HMI 54, information such as: what is the desired braking requirement (whether to slow down or coast or accelerate); and when is the desired braking condition expected to be reached (what is the desired speed at a location C). In a preferred and non-limiting embodiment, example, or aspect, based on this input to the HMI 54, HEU 26 can determined the total braking requirement of the train that can be delivered by setting the percentage of braking of each car 18 independently of each other car based on things like: the health of each brake on each rail car; how much of the brake's behavior will be impacted by the type/amount of cargo being hauled in each rail car; the impact of the environment on the braking behavior; and the like.

In a preferred and non-limiting embodiment, example, or aspect, HEU 26 can set the percentage of braking of each car 18 independently of each other car based on data or information acquired on the present output(s) or about real-time output(s) of one, or more, or all of the foregoing sources or sensors in any suitable and/or desirable manner and/or based on predicated data or information determined from prior data or information acquired from the output(s) of the one or more of the sources or sensors. In the latter scenario, (prior data or information acquired from one or more of the sources or sensors), HEU can be programmed to predict the data or information used by HUE 26 to set the percentage of braking of each car 18 independently of each other in any of the manners described herein.

In a preferred and non-limiting embodiment, example, or aspect, HEU 26 can be programmed to consider any one or more or all of the foregoing conditions, e.g., without limitation, brake wear, weather/environmental conditions, track adhesion, car loading, coupler load, wheel flat, and brake stain, when setting the percentage of braking of each car 18 independently of each other car. In a preferred and non-limiting embodiment, example, or aspect, weighting can be used by HEU to favor one or more these conditions over others. The weighting used with each condition can be varied by HEU 26 dynamically during the train's travel from location A to location B based on conditions encountered by train 14. For example, when train 14 is travelling in dry conditions on level ground, the weighting used by HEU 26 can favor brake wear over other conditions when setting the percentage of braking of each car 18 independently of each other car. In another example, when train 14 is travelling in snowy or icy conditions in hilly terrain, the weighting used by HEU 26 can favor weather/environmental conditions over other conditions when setting the percentage of braking of each car 18 independently of each other car.

In a preferred and non-limiting embodiment, example, or aspect, the weighting used for two or more of these conditions can be blended and modified by HEU 26 in any suitable and/or desirable manner to that allows the percentage of braking of each car 18 to be set independently of each other car to achieve a braking solution or requirement for the entire train rather than a braking solution for each rail car. In a preferred and non-limiting embodiment, example, or aspect, HEU 26 can, via one or more or all of the foregoing sources or sensors on the cars 18, monitor the dynamic behavior of each rail car and that of the entire train and can alter the percent braking provided by each car of an initial group (there can be more than one group) of one or more rail cars with the objective of causing the most stable braking solution for the train such that a desired speed, or stop, is achieved when the train reaches a location C.

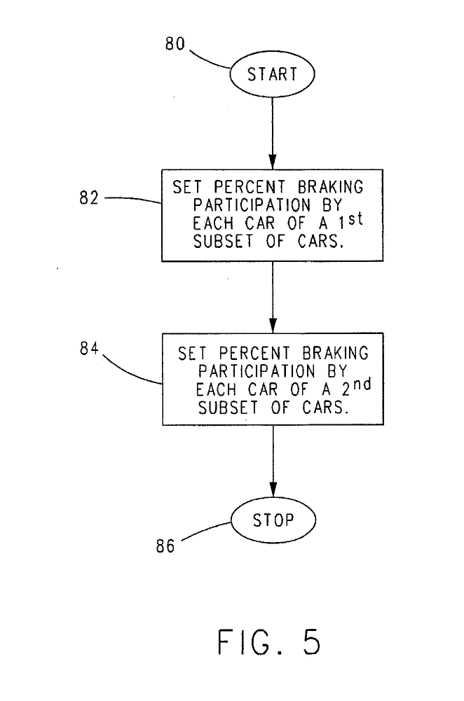

With reference to FIG. 5, in a method of braking in accordance with the principles described herein, the method initially advances from a start step 80 to a step 82 wherein the percent braking participation by each car of a first subset of cars is set. In a preferred and non-limiting embodiment, example, or aspect, the percent braking participation by each car of the first subset of cars can set independently of the percent braking participation by each other car of the first subset of cars. Next, the method advances to step 84, wherein the percent braking participation by each car of a second subset of cars is set independently of the percent braking participation by each other car of the second subset of cars. Herein, each subset of cars can include one or more cars and the percent braking participation by each car can be set between 0% braking and full braking. Finally, the method advances to stop step 86. However, this method is not to be construed in a limiting sense.

In a preferred and non-limiting embodiment, example, or aspect, the method advancing to step 84 can be based on changing conditions sensed by sources or sensors, e.g., without limitation, change in brake wear, change in weather/environmental conditions, change in track adhesion, change in car loading, change in coupler load, change in wheel flat, change in brake stain, or a change in any other condition that can affect braking of the train. However, this is not to be construed in a limiting sense since these and any other conditions described herein or known in the art can be monitored and used as an aid changing the percent braking participation by each car.

In a preferred and non-limiting embodiment, example, or aspect, HEU 26 may determine the gradient of the track as the train proceeds from A to B and can determine the percent braking participation by each car considering the positive impact of gravity (if travel is uphill) or the negative impact of gravity (if travel is downhill). In a preferred and non-limiting embodiment, example, or aspect, HUE 26 can determine the percent braking participation by each car based on the adhesion of the wheels to the track (or the lack of it). In a preferred and non-limiting embodiment, example, or aspect, HUE 26 can determine the percent braking participation by each car based on weather conditions prevalent in the vicinity of the train based on actual measurement from equipment on the train or remotely via observation from satellites and radar (Doppler, etc.). In a preferred and non-limiting embodiment, example, or aspect, HUE 26 can determine the percent braking participation by each car based on curvature of the rail track (super elevation). In a preferred and non-limiting embodiment, example, or aspect, HUE 26 can determine the percent braking participation by each car by requiring all the rail cars to participate in the braking in case of an emergency condition that requires 120% braking. In a preferred and non-limiting embodiment, example, or aspect, HEU 26 can determine the percent braking participation by each car using any combination of track gradient, wheel adhesion, track curvature, emergency conditions, or any other condition described herein or known in the art.

In a preferred and non-limiting embodiment, example, or aspect, HUE 26 can determined the initial percent braking participation by each car based on one or more above conditions, can involve the braking of rail cars 18-1, 18-2, and 18-5. Upon braking, and based on monitoring of dynamic behavior of the train and health of individual subsystem on each rail car and locomotive, a revised percent braking participation by each car can alter the configuration of the participating rail cars by now requiring braking by rail cars 18-1, 18-3, and 18-4 (cars 18-2, 18-5 were dropped while cars 18-3, 18-4 were added). If, by a certain threshold (time or distance or behavior or combinations), the percent braking participation by each car is proving to be insufficient or incapable of slowing or stopping the train, the percent braking participation by each car can be modified to include additional rail cars or all of the rail cars.

As can be seen, disclosed herein is a method of braking a plurality of rail cars of a train while travelling or moving on a mainline track that includes a locomotive processor onboard a locomotive of the train in communication with a rail car processor of each rail car of the train, the method comprising: (a) the locomotive processor providing to each rail car processor of a first subset of the rail cars a unique braking command that is independent of the braking command provided to each other rail car processor of the first subset of rail cars, wherein each braking command includes a level or percentage of braking the brakes of the rail car are to assume; and (b) in response to the braking command provided to each rail car processor of the first subset of the rail cars in step (a), the rail car processor causing the brakes of the rail car to assume the level or percentage of braking included in the unique braking command provided to the rail car processor. In step (a), the unique braking command provided to each rail car processor of the first subset of the rail cars can be provided on or about the same time.

In a preferred and non-limiting embodiment, example, or aspect, the unique braking command provided to each rail car processor of the first subset of the rail cars can be based on data regarding the rail car, the train, or both provided to the locomotive processor.

In a preferred and non-limiting embodiment, example, or aspect, the data can include predicted or actual data regarding one or more of the following: a health of the braking system of one or more of the rail cars of the train; one or more environmental conditions in a vicinity of the train; dynamic behavior of one or more rail cars of the train while travelling or moving or during braking; topology of a track between a present location and a future location of the train; and a load carried by one or more of the rail cars.

In a preferred and non-limiting embodiment, example, or aspect, the data regarding the health of the braking system can include one or more of the following: actual or estimated wear or life of a brake shoe/pad; actual or estimated wear of the brake shoe/pad based on the load carried by one or more of the rail cars of the train; and actual or estimated wear of the brake shoe/pad based on G forces of one or more rail cars of the train while travelling or moving.

In a preferred and non-limiting embodiment, example, or aspect, the actual or estimated wear or life of a brake shoe/pad can be determined from optical data of the brake shoe/pad acquired by a camera.

In a preferred and non-limiting embodiment, example, or aspect, the one or more environmental conditions can include one or more of the following: temperature, wind speed, wind direction, humidity, the presence or absence of ice or snow on the track upon which the train is travelling, and precipitation.

In a preferred and non-limiting embodiment, example, or aspect, the data regarding the one or more environmental conditions can be received wirelessly by the locomotive processor from a source remote from the train.

In a preferred and non-limiting embodiment, example, or aspect, the data regarding the dynamic behavior of one or more rail cars of the train while travelling or moving or during braking can include one or more of the following: a force on a coupler; rate of change of velocity (acceleration or deceleration) of the train; G forces of one or more rail cars of the train; pitch or roll of one or more rail cars of the train; and track adhesion determined based on a difference between a linear speed of a wheel of at least one rail car and a speed of the train.

In a preferred and non-limiting embodiment, example, or aspect, the data regarding topology can include one or more of the following: track gradient; track curvature; and track elevation.

In a preferred and non-limiting embodiment, example, or aspect, the load carried by one of the rail cars of the train can be determined by one or more load cells mounted to the rail car.

In a preferred and non-limiting embodiment, example, or aspect, the method can further include, following step (b): (c) the locomotive processor providing to each rail car processor of a second subset of the rail cars a unique braking command that is independent of the braking command provided to each other rail car processor of the second subset of rail cars; and (d) in response to the braking command provided to each rail car processor of the second subset of the rail cars in step (c), the rail car processor causing the brakes of the rail car to assume the level or percentage of braking included in the unique braking command provided to the rail car processor, wherein the first and second subsets of rail cars are different. In step (c), the unique braking command provided to each rail car processor of the first subset of the rail cars can be provided on or about the same time.

In a preferred and non-limiting embodiment, example, or aspect, step (c) can be based on a changing dynamic response of the first subset of rail cars. In a preferred and non-limiting embodiment, example, or aspect, step (c) can include self-correction or modification of the unique braking commend provided to each rail car to ease the braking forces or require additional braking force based on achieved braking and a desired braking condition for a distance between the present position of the train and a destination point where a desired speed for the train is required in order to safely proceed. The percent braking provided by one or more or all of the cars of the train can be dynamically adjusted and/or reduced as the train decelerates to avoid braking in a manner that causes a sudden lurch of the train, e.g., the overall braking of the train is reduced as the train nears a stopping point or decelerates. In some cases, the destination point may also dynamically change to a different position further down the track or move closer to the train.

Also disclosed is a method of braking a plurality of rail cars of a train while travelling or moving on a mainline track, wherein each rail car includes a rail car processor that is operative for controlling the brakes of the rail car, the method comprising: (a) each rail car processor of a first subset of the rail cars receiving a braking command prepared exclusively for the rail car processor; and (b) in response to step (a), each rail car processor of the first subset of the rail cars causing the brakes of its rail car to assume a level or percentage of braking included in the braking command received by the rail car processor in step (a). In step (a), the braking command received by each rail car processor of the first subset of the rail cars can be received on or about the same time.

In a preferred and non-limiting embodiment, example, or aspect, the method can further include: (c) following step (b), each rail car processor of a second subset of the rail cars receiving a braking command prepared exclusively for the rail car processor; and (d) in response to step (c), each rail car processor of the second subset of the rail cars causing the brakes of its rail car to assume a level or percentage of braking included in the braking command received by the rail car processor in step (c), wherein the first and second subsets of rail cars are different. In step (a), the braking command received by each rail car processor of the second subset of the rail cars can be received on or about the same time.

Also disclosed is a method of braking a plurality of rail cars of a train while travelling or moving on a mainline track, comprising: (a) a locomotive processor providing to each rail car processor of a first subset of the rail cars a braking command that is prepared exclusively for the rail car processor; (b) each rail car processor of the first subset of rail cars receiving the braking command provided to the rail car processor in step (a); (c) each rail car processor of the first subset of rail cars processing the braking command received in step (b); and (d) each rail car processor of the first subset of rail cars setting the brakes of its rail car to a level or percentage of braking included in the braking command processed in step (c) for the rail car processor, whereupon the brakes of each rail car of the first subset of rail cars are set to the same or a different percentage of braking than the brakes any other rail car of the first subset of rail cars.

In a preferred and non-limiting embodiment, example, or aspect, the method can further comprise, following step (d): (e) the locomotive processor providing to each rail car processor of a second subset of the rail cars a braking command that is prepared exclusively for the rail car processor; (f) each rail car processor of the second subset of rail cars receiving the braking command provided to the rail car processor in step (e); (g) each rail car processor of the second subset of rail cars processing the braking command received in step (f); and (h) each rail car processor of the second subset of rail cars setting the brakes of its rail car to a level or percentage of braking included in the braking command processed in step (g) for the rail car processor, whereupon the brakes of each rail car of the second subset of rail cars are set to the same or a different percentage of braking than the brakes any other rail car of the first subset of rail cars, wherein the first and second subsets of rail cars are different.

In a preferred and non-limiting embodiment, example, or aspect, each subset of rail cars can include one or more rail cars.

Also disclosed is system for controlling braking of a plurality of rail cars of a train while travelling or moving on a mainline track, the system comprising: a rail car processor associated with each rail car, wherein each rail car processor, operating under the control of a rail car software program, is operative, in response to a unique braking command received by the rail car processor, to set brake(s) of the rail car to a level or percentage commanded by the braking command; a communication network linking the rail car processors of the plurality of rail cars; and a control processor in communication with each rail car processor via the communication network, wherein the control processor, operating under the control of a control software program, is operative for transmitting to each rail car processor the unique braking command prepared exclusively for the rail car processor and which causes the rail car processor to set the brake(s) of the rail car to a level or percentage of braking associated with the unique braking command that is the same or different than a level or percentage of braking of the brake(s) of each other rail car are set.

In a preferred and non-limiting embodiment, example, or aspect, each rail car processor can include a data address that is unique to said rail car processor; and the unique braking command provided to each rail car processor is addressed to the data address of the rail car processor.

Also disclosed is a method of braking a plurality of rail cars of a train while travelling or moving on a mainline track, comprising: (a) issuing first and second brake commands to first and second rail cars, wherein the first brake command includes a first level or percentage of braking of the brake(s) of the first rail car, wherein the second brake command includes a second, different level or percentage of braking of the brake(s) of the second rail car; and (b) in response to step (a), setting the brake(s) of the first and second rail cars of the plurality of the rail cars to the respective first and second levels or percentages of braking included in the first and second brake commands. In a preferred and non-limiting embodiment, example, or aspect, the first and second levels or percentages of braking can be different.

In a preferred and non-limiting embodiment, example, or aspect, the method can further include, following step (b): (c) issuing third and fourth brake commands to the first and second rail cars, wherein the third brake command includes a third level or percentage of braking of the brake(s) of the first rail car, wherein the fourth brake command includes a fourth level or percentage of braking of the brake(s) of the second rail car that is different than the third level or percentage of braking; and (d) in response to step (c), setting the brake(s) of the first and second rail cars of the plurality of the rail cars to the respective third and fourth levels or percentages of braking included in the third and fourth brake commands. In a preferred and non-limiting embodiment, example, or aspect, the third and fourth levels or percentages of braking can be different.

Also disclosed is a method for segmented rail car braking of one or more rail cars of a train while travelling or moving on a mainline track, wherein each rail car is equipped with an electronically controllable braking system, the method comprising: (a) identifying one or more groups of one or more rail cars from the train for purposes of braking; and (b) commanding each of the one or more groups of one or more rail cars to brake using a custom braking profile unique to that group in order to achieve a desired overall braking response from the train.

In a preferred and non-limiting embodiment, example, or aspect, the method can further comprise defining the custom braking profile for each of the one or more groups of the one or more rail cars based on at least one dynamic behavior of each of the rail cars in each of the one or more groups. In a preferred and non-limiting example, embodiment, or aspect, the dynamic behavior of each rail car can include one or more of the following: rate of change of velocity, G force, pitch or roll behavior, and force on at least one coupler.

In a preferred and non-limiting embodiment, example, or aspect, the method can further comprise defining the custom braking profile to result in a specific dynamic behavior of each of the rail cars in each of the one or more groups.

In a preferred and non-limiting embodiment, example, or aspect, the method can further comprise defining the custom braking profile for each of the one or more groups of one or more rail cars based on topology of a track upon which the train is of a traveling or moving from a present location to a future location located further down the track. In a preferred and non-limiting example, embodiment, or aspect, the topology of the track can include positive track gradient, negative track gradient, track curvature, and track elevation.

In a preferred and non-limiting embodiment, example, or aspect, the method can further comprise defining the custom braking profile for each of the one or more groups of one or more rail cars based on a health of a braking system on each of the one or more rail cars in the train. In a preferred and non-limiting example, embodiment, or aspect, the health of the braking system on each car can include wear on the brake discs, wear on the brake shoes, estimated remaining life of the brake discs/shoes, estimated wear based on the cargo carried therein, and estimated wear based on the G forces exerted during the travel.

In a preferred and non-limiting embodiment, example, or aspect, the method can further comprise dynamically altering a composition of rail cars in each of the one or more groups based on dynamic response of the train during braking. In a preferred and non-limiting example, embodiment, or aspect, the groups may be consecutive rail cars, or discrete rail cars. In a preferred and non-limiting example, embodiment, or aspect, the selection of each group may be made based on desired overall dynamic response of the group as a whole rather than individual rail cars. In a preferred and non-limiting example, embodiment, or aspect, the selection of each group may also be based on individual dynamic response of each rail car.

In a preferred and non-limiting embodiment, example, or aspect, steps (a) and (b) can be based on a future location of the train selected by a train operator.

In a preferred and non-limiting embodiment, example, or aspect, the method can further comprise selecting the future location based on input from a console onboard the train or via a wireless device remote from the train. In a preferred and non-limiting example, embodiment, or aspect, the amount of braking, the number of groups and the number of rail cars in each group to accomplish said amount of braking can be determined by the HEU based on a train speed profile, or distance for braking, or distance to stop based on the selected future location.

In a preferred and non-limiting embodiment, example, or aspect, the method can further comprise defining the custom braking profile for each of the one or more groups of one or more rail cars based on environmental conditions in a vicinity of at least one or more rail cars in the train. In a preferred and non-limiting example, embodiment, or aspect, the environmental conditions can include, without limitation, one or more of the following: percent humidity; wind direction; wind speed; the presence (or absence) of rain, ice, and conditions that affect traction; track adhesion; and visibility.

In a preferred and non-limiting embodiment, example, or aspect, the method can further comprise defining the custom braking profile for each of the one or more groups of one or more rail cars based on physical characteristics of the train. In a preferred and non-limiting example, embodiment, or aspect, the physical characteristics of the train can include one or more of the following: acceleration, deceleration, G forces, pitch or roll behavior, coupler forces, in-car forces, wheel-slip, and wheel-spin.

In a preferred and non-limiting embodiment, example, or aspect, the method can further comprise dynamically altering the custom braking profile for each of the rail cars in each of the one or more groups in about real-time.

In a preferred and non-limiting embodiment, example, or aspect, the method can further comprise selecting the future location based on input to a navigation equipment onboard the train. In a preferred and non-limiting example, embodiment, or aspect, a train operator can enter the future location, e.g., a destination point, from a GPS console/electronic map.

In a preferred and non-limiting embodiment, example, or aspect, the method can further comprise selecting the future location via a wayside dispatching system.

In a preferred and non-limiting embodiment, example, or aspect, as the train continues to decelerate, the dynamic response of the groups of rail cars may change. In a preferred and non-limiting embodiment, example, or aspect, this can require a self-correction or modification of the custom braking profiles such that it can ease the braking forces or require additional braking force based on achieved braking and distance to comply. Distance to comply may be the distance between present position of the train and the destination point where a desired speed for the train is required in order to safely proceed. The distance to comply can continuously reduce as the train travels. In some cases, the destination point may also dynamically change to a different position further down the track or move closer to the train.

In a preferred and non-limiting embodiment, example, or aspect, one or more processor or controller 34 described herein can be a microprocessor. Also or alternatively, one or more processor or controller 34 can be implemented using special purpose circuitry, with or without software, such as a Application-Specific Integrated Circuit (ASIC) or Field-Programmable Gate Array (FPGA). In a preferred and non-limiting embodiment, example, or aspect, one or more processor or controller 34 described herein can be implemented using hardwired circuitry without software, or in combination with software. Thus, the foregoing description is limited neither to any specific combination of hardware circuitry and software, nor to any particular source for the software executed by the processor or controller 34.

Although the invention has been described in detail for the purpose of illustration based on what is currently considered to be the most practical preferred and non-limiting embodiments, examples, or aspects, it is to be understood that such detail is solely for that purpose and that the invention is not limited to the disclosed preferred and non-limiting embodiments, examples, or aspects, but, on the contrary, is intended to cover modifications and equivalent arrangements that are within the spirit and scope of the appended claims. For example, it is to be understood that the present invention contemplates that, to the extent possible, one or more features of any preferred and non-limiting embodiment, example, or aspect can be combined with one or more features of any other preferred and non-limiting embodiment, example, or aspect.

The invention claimed is:

1. A method of braking a plurality of rail cars of a train while travelling or moving on a mainline track that includes a locomotive processor onboard a locomotive of the train in communication with a rail car processor of each rail car of the train, the method comprising:
(a) the locomotive processor providing to each rail car processor of a first subset of the rail cars a unique braking command that is independent of the braking command provided to each other rail car processor of the first subset of rail cars, wherein each braking command includes a level or percentage of braking the brakes of the rail car are to assume; and
(b) in response to the braking command provided to each rail car processor of the first subset of the rail cars in step (a), the rail car processor causing the brakes of the rail car to assume the level or percentage of braking included in the unique braking command provided to the rail car processor.

2. The method of claim 1, wherein the unique braking command provided to each rail car processor of the first subset of the rail cars is based on data regarding the rail car, the train, or both provided to the locomotive processor.

3. The method of claim 2, wherein the data includes predicted or actual data regarding one or more of the following:
a health of the braking system of one or more of the rail cars of the train;
one or more environmental conditions in a vicinity of the train;
dynamic behavior of one or more rail cars of the train while travelling or moving or during braking; and
topology of a track between a present location and a future location of the train; and
a load carried by one or more of the rail cars.

4. The method of claim 3, wherein the data regarding the health of the braking system includes one or more of the following:
actual or estimated wear or life of a brake shoe/pad;
actual or estimated wear of the brake shoe/pad based on the load carried by one or more of the rail cars of the train; and
actual or estimated wear of the brake shoe/pad based on G forces of one or more rail cars of the train while travelling or moving.

5. The method of claim 4, wherein the actual or estimated wear or life of a brake shoe/pad is determined from optical data of the brake shoe/pad acquired by a camera or based on an output of an electrical/electronic circuit detecting the useable brake material or amount of useable brake material.

6. The method of claim 3, wherein the one or more environmental conditions includes one or more of the following: temperature, wind speed, wind direction, humidity, the presence or absence of ice or snow on the track upon which the train is travelling, and precipitation.

7. The method of claim 3, wherein the data regarding the one or more environmental conditions is received wirelessly by the locomotive processor from a source remote from the train.

8. The method of claim 3, wherein the data regarding the dynamic behavior of one or more rail cars of the train while travelling or moving or during braking includes one or more of the following:
a force on a coupler;
rate of change of velocity (acceleration or deceleration) of the train;
G forces of one or more rail cars of the train;
pitch or roll of one or more rail cars of the train; and
track adhesion determined based on a difference between a linear speed of a wheel of at least one rail car and a speed of the train.

9. The method of claim 8, wherein the data regarding topology includes one or more of the following:
track gradient;
track curvature; and
track elevation.

10. The method of claim 3, wherein the load carried by one of the rail cars of the train is determined by one or more load cells mounted to the rail car.

11. The method of claim 1, further including, following step (b):
(c) the locomotive processor providing to each rail car processor of a second subset of the rail cars a unique braking command that is independent of braking command provided to each other rail car processor of the second subset of rail cars; and
(d) in response to the braking command provided to each rail car processor of the second subset of the rail cars in step (c), the rail car processor causing the brakes of the rail car to assume the level or percentage of braking included in the unique braking command provided to the rail car processor, wherein the first and second subsets of rail cars are different.

12. A method of braking a plurality of rail cars of a train while travelling or moving on a mainline track, wherein each rail car includes a rail car processor that is operative for controlling the brakes of the rail car, the method comprising:
(a) each rail car processor of a first subset of the rail cars receiving a braking command prepared exclusively for the rail car processor; and
(b) in response to step (a), each rail car processor of the first subset of the rail cars causing the brakes of its rail car to assume a level or percentage of braking included in the braking command received by the rail car processor in step (a).

13. The method of claim 12, further including:
(c) following step (b), each rail car processor of a second subset of the rail cars receiving a braking command prepared exclusively for the rail car processor; and
(d) in response to step (c), each rail car processor of the second subset of the rail cars causing the brakes of its rail car to assume a level or percentage of braking included in the braking command received by the rail car processor in step (c), wherein the first and second subsets of rail cars are different.

14. A method of braking a plurality of rail cars of a train while travelling or moving on a mainline track, comprising:
(a) a locomotive processor providing to each rail car processor of a first subset of the rail cars a braking command that is prepared exclusively for the rail car processor;
(b) each rail car processor of the first subset of rail cars receiving the braking command provided to the rail car processor in step (a);
(c) each rail car processor of the first subset of rail cars processing the braking command received in step (b); and
(d) each rail car processor of the first subset of rail cars setting the brakes of its rail car to a level or percentage of braking included in the braking command processed in step (c) for the rail car processor, whereupon the brakes of each rail car of the first subset of rail cars are set to the same or a different percentage of braking than the brakes any other rail car of the first subset of rail cars.

15. The method of claim 14, further comprising, following step (d):
(e) the locomotive processor providing to each rail car processor of a second subset of the rail cars a braking command that is prepared exclusively for the rail car processor;
(f) each rail car processor of the second subset of rail cars receiving the braking command provided to the rail car processor in step (e);
(g) each rail car processor of the second subset of rail cars processing the braking command received in step (f); and
(h) each rail car processor of the second subset of rail cars setting the brakes of its rail car to a level or percentage of braking included in the braking command processed in step (g) for the rail car processor, whereupon the brakes of each rail car of the second subset of rail cars are set to the same or a different percentage of braking than the brakes of any other rail car of the second subset of rail cars, wherein the first and second subsets of rail cars are different.

16. The method of claim 14, wherein each subset of rail cars includes one or more rail cars.

17. A system for controlling braking of a plurality of rail cars of a train while travelling or moving on a mainline track, the system comprising:
a rail car processor associated with each rail car, wherein each rail car processor, operating under the control of a rail car software program, is operative, in response to a unique braking command received by the rail car processor, to set brake(s) of the rail car to a level or percentage commanded by the braking command;
a communication network linking the rail car processors of the plurality of rail cars; and
a control processor in communication with each rail car processor via the communication network, wherein the control processor, operating under the control of a control software program, is operative for transmitting to each rail car processor the unique braking command prepared exclusively for the rail car processor and which causes the rail car processor to set the brake(s) of the rail car to a level or percentage of braking associated with the unique braking command that is the same or different than a level or percentage of braking of the brake(s) of each other rail car are set.

18. The system of claim 17, wherein:
each rail car processor includes a data address that is unique to said rail car processor; and
the unique braking command provided to each rail car processor is addressed to the data address of the rail car processor.

19. A method of braking a plurality of rail cars of a train while travelling or moving on a mainline track, comprising:
(a) issuing first and second brake commands to first and second rail cars, wherein the first brake command includes a first level or percentage of braking of the brake(s) of the first rail car, wherein the second brake command includes a second, different level or percentage of braking of the brake(s) of the second rail car; and
(b) in response to step (a), setting the brake(s) of the first and second rail cars of the plurality of the rail cars to the respective first and second levels or percentages of braking included in the first and second brake commands.

20. The method of claim 19, further including, following step (b):
(c) issuing third and fourth brake commands to the first and second rail cars, wherein the third brake command includes a third level or percentage of braking of the brake(s) of the first rail car, wherein the fourth brake command includes a fourth level or percentage of braking of the brake(s) of the second rail car that is different than the third level or percentage of braking; and
(d) in response to step (c), setting the brake(s) of the first and second rail cars of the plurality of the rail cars to the respective third and fourth levels or percentages of braking included in the third and fourth brake commands.

21. A method for segmented rail car braking of one or more rail cars of a train while travelling or moving on a mainline track, each rail car equipped with an electronically controllable braking system, the method comprising:
identifying one or more groups of one or more rail cars of the train for purposes of braking; and
commanding each of the one or more groups of one or more rail cars to brake using a custom braking profile unique to that group in order to achieve a desired overall braking response from the train.

22. The method of claim 21, further comprising defining the custom braking profile for each of the one or more groups of one or more rail cars based on at least one dynamic behavior of each of the rail cars in each of the one or more groups.

23. The method of claim 21, further comprising defining the custom braking profile to result in a specific dynamic behavior of each of the rail cars in each of the one or more groups.

24. The method of claim 21, further comprising defining the custom braking profile for each of the one or more groups of one or more rail cars based on topology of a track upon which the train is traveling or moving from a present location to a future location located further down the track.

25. The method of claim 21, further comprising defining the custom braking profile for each of the one or more groups of one or more rail cars based on health of braking system on each of the one or more rail cars in the train.

26. The method of claim 21, further comprising dynamically altering a composition of rail cars in each of the one or more groups based on dynamic response of the train during braking.

27. The method of claim 24, further comprising requiring setting the future location by an operator onboard the train.

28. The method of claim 24, further comprising setting the future location based on input to a processor onboard the train.

29. The method of claim 21, further comprising defining the custom braking profile for each of the one or more groups of one or more rail cars based on environmental conditions in a vicinity of at least one or more rail cars of the train.

30. The method of claim 21, further comprising defining the custom braking profile for each of the one or more groups of one or more rail cars based on physical characteristics of the train.

31. The method of claim 21, further comprising dynamically altering the custom braking profile for each of the rail cars in each of the one or more groups in about real-time.

32. The method of claim 24, further comprising selecting the future location based on input to a navigation equipment onboard the train.

33. The method of claim 24, further comprising selecting the future location via a wayside dispatching system.

34. A method for braking a train comprising plurality of railcars, the method comprising:
identifying a group of one or more railcars that would participate in the braking;
providing a specific percentage braking command for each of the one or more railcars; and
monitoring braking performance delivered by the braking of the one or more railcars.

35. The method of claim 34, further comprising, performing at least one of the following:
altering the specific percentage braking command for each of the one or more railcars participating in the braking; and
altering the composition of the group of the one or more railcars by adding a new railcar to the group to participate in the braking, removing an existing railcar from the group of the one or more railcars participating in the braking, or both.

36. The method of claim 34, further comprising:
identifying a second group of one or more railcars that would participate in the braking;
providing a specific percentage braking command for each of the one or more railcars of the second group; and
monitoring braking performance delivered by the braking of the one or more railcars of the second group.

37. The method of claim 34, further comprising performing at least one of the following:
altering the specific percentage braking command for each of the one or more railcars of the second group; and
altering the composition of the second group of the one or more railcars by adding new railcars to the group to participate in the braking, removing an existing railcar from the group of the one or more railcars participating in the braking, or both.
